(19) United States
(12) Patent Application Publication
(10) Pub. No.: US 2026/0368689 A1
(43) Pub. Date: Nov. 19, 2026

(54) LOGISTICS PLANNING PROGRAM, LOGISTICS PLANNING SYSTEM, AND LOGISTICS PLANNING METHOD

(71) Applicant: DENSO CORPORATION, Kariya-city (JP)

(72) Inventors: Akito AICHI, Kariya-city (JP); Akira MIKI, Kariya-city (JP)

(21) Appl. No.: 19/547,371

(22) Filed: Feb. 23, 2026

(30) Foreign Application Priority Data
Mar. 20, 2025 (JP) 2025-046144

(51) Int. Cl. G06Q 10/083

(52) U.S. Cl. CPC G06Q 10/0843

(57) ABSTRACT

A logistics planning system including a delivery plan creation unit and a loading plan creation unit is provided. The delivery plan creation unit creates a delivery plan for a transporter to transport packages. The loading plan creation unit creates a loading plan for loading the packages onto the transporter. The delivery plan creation unit and the loading plan creation unit create the delivery plan and the loading plan in parallel and perform an optimization process to optimize the delivery plan and the loading plan.

### CROSS-REFERENCE TO RELATED APPLICATIONS

The present application claims the benefit of priority from Japanese Patent Application No. 2025-046144 filed on Mar. 20, 2025. The entire disclosure of the above application is incorporated herein by reference.

### TECHNICAL FIELD

The present disclosure relates to a technology of creating logistics plans.

### BACKGROUND

There is an optimization evaluation system that creates images of instructions for loading packages on a pallet and instructions for loading the pallet on a vehicle and creates a delivery schedule.

### SUMMARY

According to an aspect of the present disclosure, a logistics planning system is provided that includes a delivery plan creation unit and a loading plan creation unit. The delivery plan creation unit creates a delivery plan for a transporter to transport packages. The loading plan creation unit creates a loading plan for loading the packages onto the transporter. The delivery plan creation unit and the loading plan creation unit create the delivery plan and the loading plan in parallel and perform an optimization process to optimize the delivery plan and the loading plan.

### BRIEF DESCRIPTION OF DRAWINGS

FIG. 1 is a block diagram illustrating an overview of a logistics planning system according to one embodiment of the present disclosure.

FIG. 2 is a block diagram illustrating details of an optimization process.

FIG. 3 is a diagram illustrating details of functions implemented in a platform unit.

FIG. 4 is a diagram illustrating a flow of processes executed on a platform of a basic system.

FIG. 5 is a diagram illustrating a flow of processes executed on a platform of a developed system.

FIG. 6 is a diagram illustrating details of functions implemented in an input processing unit.

FIG. 7 is a diagram illustrating a flow of processes executed by the input processing unit of the basic system.

FIG. 8 is a diagram illustrating a flow of processes executed by the input processing unit of the developed system.

FIG. 9 is a diagram illustrating details of functions implemented in a delivery plan creation unit.

FIG. 10 is a diagram illustrating a derivation relationship of multiple use cases in the delivery plan creation unit.

FIG. 11 is a diagram illustrating a flow of processes executed by the delivery plan creation unit.

FIG. 12 is a diagram illustrating details of processes executed by the delivery plan creation unit of the basic system.

FIG. 13 is a diagram illustrating a specific example of a delivery plan created by the delivery plan creation unit.

FIG. 14 is a diagram illustrating a specific example of a delivery plan further applied with a standard rule.

FIG. 15 is a diagram illustrating a specific example of a delivery plan utilizing container swap.

FIG. 16 is a diagram illustrating a specific example of a delivery plan utilizing the container swap.

FIG. 17 is a diagram illustrating a specific example of a delivery plan utilizing the container swap.

FIG. 18 is a diagram for description of a lightweight implementation of the container swap.

FIG. 19 is a diagram illustrating a specific example of a delivery plan in which multiple via-points are visited.

FIG. 20 is a diagram illustrating details of functions implemented in a loading plan creation unit.

FIG. 21 is a diagram illustrating a flow of processes executed by the loading plan creation unit of the basic system.

FIG. 22 is a diagram illustrating a flow of processes executed by the loading plan creation unit of the developed system.

FIG. 23 is a diagram illustrating details of functions implemented in an output processing unit.

FIG. 24 is a diagram illustrating a flow of processes executed by the output processing unit of the basic system.

FIG. 25 is a diagram illustrating a flow of processes executed by the output processing unit of the developed system.

### DETAILED DESCRIPTION

There is an optimization evaluation system that creates images of instructions for loading packages on a pallet and instructions for loading the pallet on a vehicle and creates a delivery schedule. This optimization evaluation system verifies whether the output of the palletizing image and the loading image as well as the output delivery schedule are efficient and optimal.

In the above system, creation of a loading plan including the palletizing image and the boarding image, and creation of a delivery plan including the delivery schedule are carried out in a predetermined order. This may make it difficult to ensure flexibility in the loading plan and the delivery plan, leading to insufficient improvement in accuracy and efficiency of these plans.

It is an object of the present disclosure to provide a logistics planning program, a logistics planning system and a logistics planning method that can create a delivery plan and a loading plan with high efficiency and high accuracy.

According to a first aspect of the present disclosure, a logistics planning program stored in a non-transitory storage medium is provided that causes at least one processor to function as: a delivery plan creation unit that creates a delivery plan for a transporter to transport packages; and a loading plan creation unit that creates a loading plan for loading the packages onto the transporter. The delivery plan creation unit and the loading plan creation unit create the delivery plan and the loading plan in parallel and perform an optimization process to optimize the delivery plan and the loading plan.

According to a second aspect of the present disclosure, a logistics planning system is provided that includes: a delivery plan creation unit that creates a delivery plan for a transporter to transport packages; and a loading plan creation unit that creates a loading plan for loading the packages onto the transporter. The delivery plan creation unit and the loading plan creation unit create the delivery plan and the loading plan in parallel and perform an optimization process to optimize the delivery plan and the loading plan.

According to a third aspect of the present disclosure, a logistics planning method executed by at least one processor of a logistics planning system that implements: a delivery plan creation unit that creates a delivery plan for a transporter to transport packages; and a loading plan creation unit that creates a loading plan for loading the packages onto the transporter is provided. The logistics planning method includes: by the delivery plan creation unit and the loading plan creation unit, creating the delivery plan and the loading plan in parallel and performing an optimization process to optimize the delivery plan and the loading plan.

In these aspects, the delivery plan for the transporter to transport packages and the loading plan for loading the packages onto the transporter are created in parallel. This facilitates ensuring flexibility in delivery plan and loading plan. As a result, via the optimization process of optimizing these, it is possible to create the deliver plan and the loading plan with high efficiency and high accuracy.

Embodiments will be described in detail with reference to the drawings.

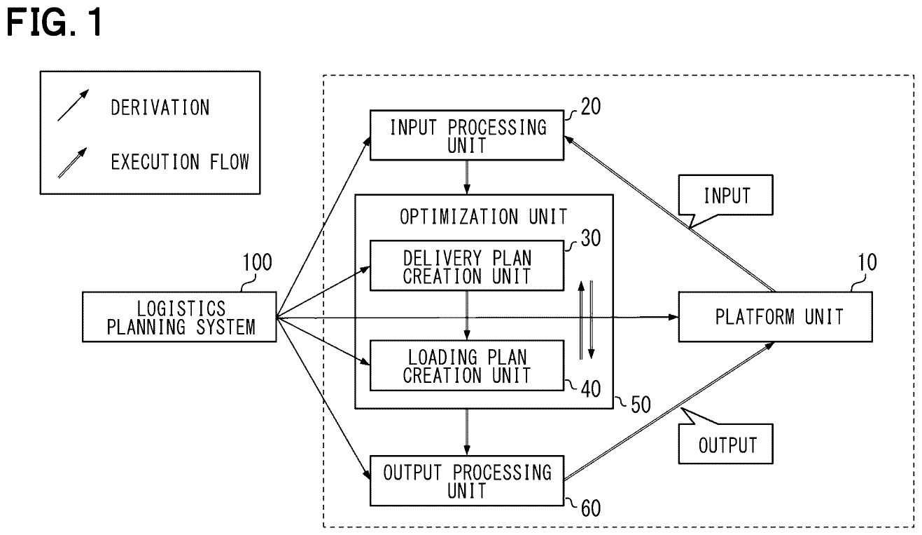

A logistics planning system 100 according to one embodiment of the present disclosure illustrated in FIG. 1 creates a logistics plan for efficient management and movement of packages using a transporter. The transporter is a vehicle able to transport packages, such as a truck and trailer. Examples of the transporter may include an aircraft, a ship, a train, a motorcycle, and a bicycle. The logistics planning system 100 selects an optimal route and a transportation method, taking into account information related to packages, transporters, and bases. By logistics plan formulation, the logistics planning system 100 makes it possible to reduce delivery costs and shorten delivery times, improving efficiency of supply chain as a whole.

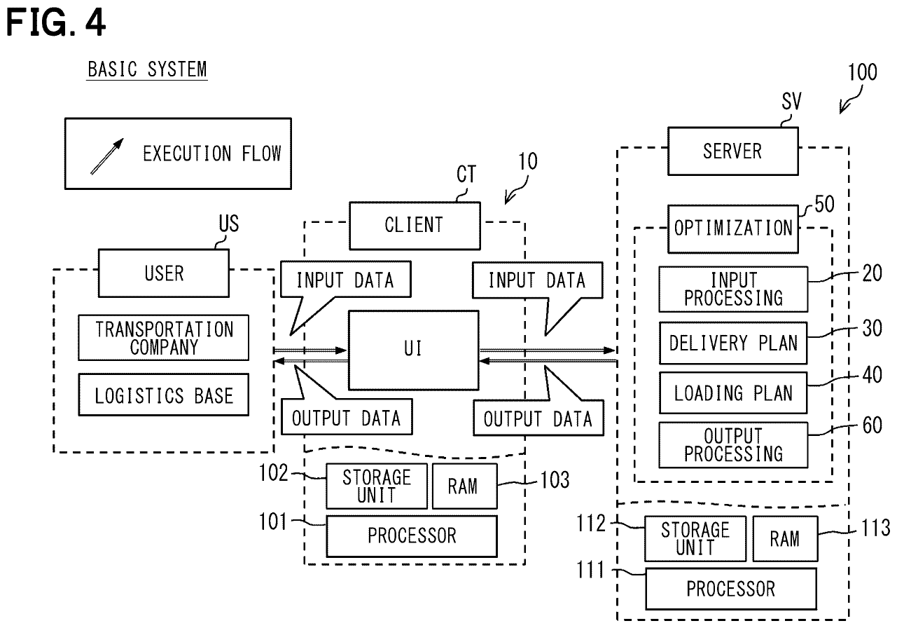

The logistics planning system 100 provides a cloud service available to multiple users US (see FIG. 4). The logistics planning system 100 includes functional units, including a platform unit 10, an input processing unit 20, a delivery plan creation unit 30, a loading plan creation unit 40, and an output processing unit 60. The platform unit 10 provides a user interface via a network. In other words, a functional unit that executes processes necessary for the user interface is the platform unit 10.

The user US transmits an input constant via the user interface and receives a decision constant determined via an optimization process by the logistics planning system 100. The input processing unit 20 and the output processing unit 60 are functional units that perform processing, by the server SV, of input/output data immediately before and after optimization. Processing of the input/output data may be performed not only by the input processing unit 20 and the output processing unit 60 but also by the platform unit 10. Specifically, the platform unit 10, the input processing unit 20, and the output processing unit 60 may be integrated.

Package information, base capability information, base-to-base information, general parameters and the like are input to the user interface. The platform unit 10 transmits these input constants to the input processing unit 20. The platform unit 10 receives decision variables for the delivery plan and the loading plan from the output processing unit 60. The decision variables for the delivery plan include: the number of tasks; linking information on a task, a departure location, and an arrival location; linking information on a task, a vehicle, and a driver; and linking information on a task, start and end clock times of loading, and start and end times of unloading. The decision variables for the loading plan include: linking information on a task and a package (capacity); and coordinate information on arrangements for loading packages and unloading packages in each task. The user interface outputs the decision variables for each of the delivery plan and the loading plan to the user US.

The logistics planning system 100 includes an optimization unit 50 for performing the optimization process for the delivery plan and the loading plan. The optimization unit 50 at least includes a delivery plan creation unit 30 and a loading plan creation unit 40. The optimization unit 50 may include at least one of the input processing unit 20 or the output processing unit 60 (see FIG. 4).

In the optimization unit 50, part of the functions of the loading plan creation unit 40 is included in the delivery plan creation unit 30, so that capacity variablizing is achieved. In addition, the optimization unit 50 has a recursive execution order with respect to creating the operation plan and the loading plan. The recursive execution order is such an order that the delivery plan is created and thereafter the loading plan is created, and if a discrepancy happens, parameters are corrected, and delivery plan optimization is done again. By the recursive execution order, the optimization unit 50 creates the delivery plan and the loading plan in parallel and optimizes the delivery plan and the loading plan. The above optimization process provides the delivery plan and the loading plan with high flexibility.

### Optimization Process Flow Details

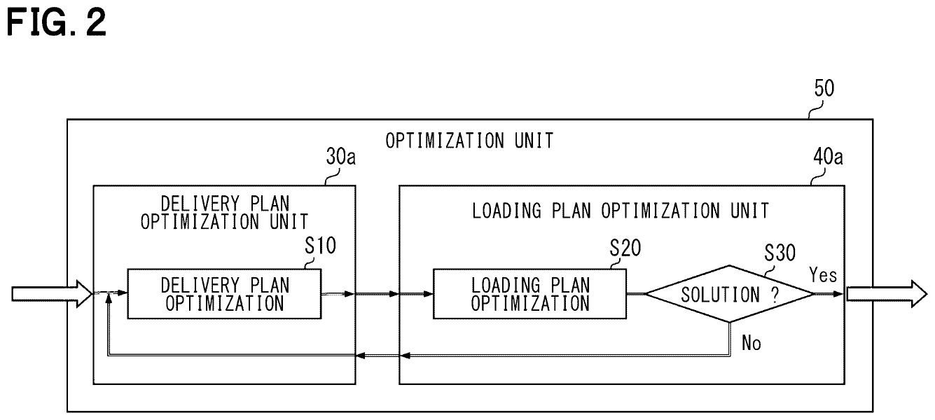

Details of the optimization process by the optimization unit 50 will be further described using FIG. 2. The optimization unit 50 includes a delivery plan optimization unit 30a of the delivery plan creation unit 30 and a loading plan optimization unit 40a of the loading plan creation unit 40.

The delivery plan optimization unit 30a performs an optimization process for the delivery plan (see S10). The delivery plan optimization unit 30a calculates a solution of CVRPTW (Capacitated Vehicle Routing Problem with Time Windows) while constraints on the time window and the capacity are variable. The constraints configured for the optimization process for the delivery plan include a time window, a maximum working time, a connection constraint, a capacity constraint, capacity variablizing, and cargo handling time variablizing. In addition, the number of vehicles and working time are configured as objective functions for the optimization process for the delivery plan.

CVRPTW is one standard type of delivery planning problems. The delivery plan optimization unit 30a is based on the CVRPTW expressed in the below rules 1 to 8. Rule 1 is that there is one depot (departure location) and multiple bases (jobs) for delivery destinations. Rule 2 is that two or more drivers (vehicles) depart from the depot, visit one or more jobs, load packages, and return to the depot. Rule 3 is that each job for the delivery destination is required visited once by any of the drivers to load the package. Rule 4 is that for each job, a visitable time frame (=time window) is designated. Rule 5 is that for each job, a required time for cargo handling is designated and each driver visiting the job stays and does cargo handling for an amount of time greater than or equal to the required time. Rule 6 is that for each job, a certain cargo quantity is designated, and each driver is not allowed to load more than the loading upper limit. That is, a total cargo quantity of jobs in charge between the departure and return is less than or equal to the loading upper limit. Rule 7 is that a time length from each driver departure from the depot to the return is less than or equal to the maximum working time without exception. Rule 8 is to find a plan that minimizes the number of drivers and the total working time within the constraints.

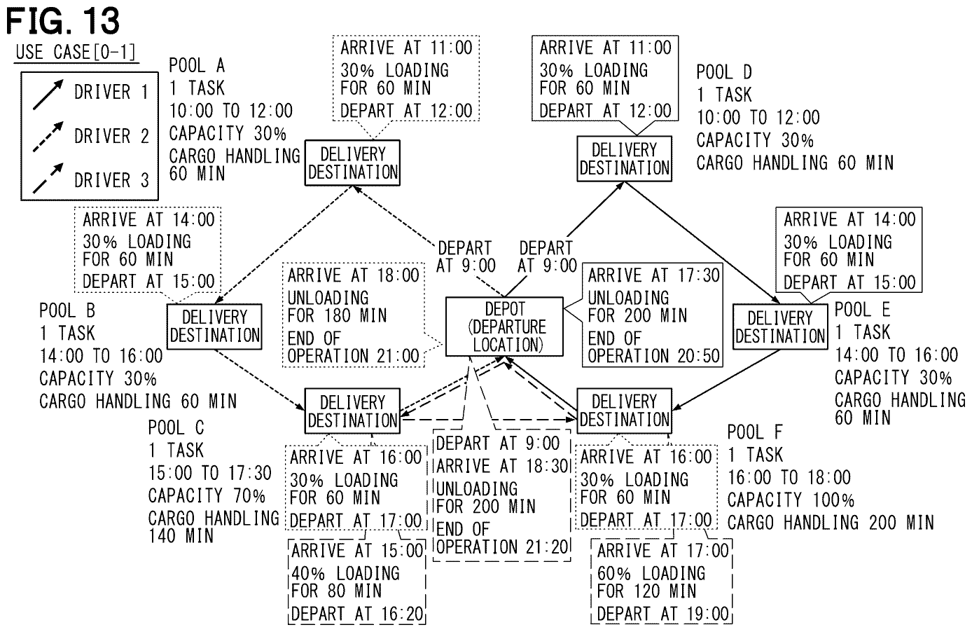

Here, “depot” above represents a departure base. In CVRPTW, every vehicle departs from the same single base and ends its operation at a time when the vehicle returns to the single base. This base is called the departure base (depot) (see FIG. 13, etc.). The above “working time” is a value representing a difference from a work start clock time to a work end clock time of a respective driver. A break time and a standby time are also included in the working time. The maximum working time is determined by law, and is 13 hours or less in principle, extendable up to 15 hours, and extendable up to 16 hours twice a week.

The delivery plan optimization unit 30a includes an exception handling for achieving parallel generation of the delivery plan and the loading plan. Specifically, when the capacity provided as “constant for each job” is designated for multiple jobs indicating loading at the same single base, the delivery plan optimization unit 30a is able to perform capacity allocation so that the total value is constant. This is the “capacity variablizing”. As for the cargo handling time provided as “constant for each job”, the delivery plan optimization unit 30a also variablizes the cargo handling time with a linear function linked to the capacity in the case of the capacity variablizing jobs. In addition, the unloading time upon arrival at the depot is also variablized by the delivery plan optimization unit 30a, depending on the number of jobs where the pickups have been done so far, as well as the job type and the capacity. This is the “cargo handling time variablizing”.

The delivery plan optimization unit 30a reads input information (overall input) from the input processing unit 20 (see FIG. 1). The input information includes the package information, the base capability information indicating the number of bases, the base-to-base information indicating a required time between bases, and the general parameters. The package information includes the number of packages, information linking the package to departure and arrival locations, and information linking the package to the time window. The base capability information includes information. The general parameters include information on a pickup task or delivery task, information indicating the maximum working time, and functions of the capacity of the vehicle and the number of tasks and the cargo handling time.

The delivery plan optimization unit 30a outputs task information of the delivery plan calculated by the optimization process to the loading plan optimization unit 40a. The task information includes information linking the task to a pool, information linking the task to the capacity, information linking the task to the start and end clock times of loading and unloading, and information linking the task to the assigned vehicle and the assigned driver. The optimization unit 50 uses the output of the delivery plan optimization unit 30a and the overall input from the input processing unit 20 to create an input for the loading plan optimization unit 40a.

The loading plan optimization unit 40a performs the loading plan optimization process (see S20). The loading plan optimization unit 40a calculates a solution of three-dimensional packing of packages. Constraints configured for the loading plan optimization process include a stable loading manner (coordinate rule for package arrangement in the same task), use of all packages, and cargo quantity allocation within a designated range. No objective function is configured for the loading plan optimization process.

The loading plan optimization unit 40a reads the input information from the delivery plan optimization unit 30a. The input information includes the package information and the task information. The package information includes the number of packages and the information linking the package to the pool. The task information includes the number of tasks, information linking the pool to the task, information linking the task to the departure and arrival locations, information linking the task to a clock time, information linking the task to the vehicle, information linking the task to the capacity, and information linking the task to the cargo handling time.

The loading plan optimization unit 40a outputs a loading plan including the information linking the task to the package, and coordinates of package arrangement in each task. The loading plan optimization unit 40a determines whether a feasible solution is found (see S30). If the feasible solution is not found (S30: NO), the delivery plan optimization unit 30a recalculate the delivery plan optimization process by correcting the package information, specifically, the relationship between the package and the capacity.

If the feasible solution is found (S30: YES), the loading plan optimization unit 40a outputs final decision information to the output processing unit 60 (see FIG. 1). In this case, an overall output of the optimization unit 50 includes task information derived from the delivery plan and information derived from loading plan. The task information includes, as described above, the number of tasks, the information linking the task to the vehicle, the information linking the task to the driver, and information linking the task to the start and end clock times of loading and unloading. The information derived from the loading plan includes, as described above, the information linking the task to the capacity and the information linking the task to the cargo handling time.

In the optimization process described so far, the loading plan and the delivery plan are able to be created in parallel using mathematical optimization, so that highly efficient and accurate plans can be created. Because of this, it is possible to achieve high flexibility in loading and delivery plans. As a result, the solution becomes accurate, and it becomes possible to handle mixed-loading transportation including partial follow-up loading and unloading.

Specifically, the delivery plan optimization unit 30a is able to create the delivery plan with the capacity variablized for each job. In addition, the loading plan optimization unit 40A is able to create an efficient and highly flexible cargo configuration. For example, the loading plan optimization unit 40a is able to create the loading plan not for loading in units of pallet but for loading packages of any standard one by one in a three-dimensional manner. The term “cargo configuration”encompasses “external shape dimensions”, “orientation”, and “packing style.”

Furthermore, because the delivery plan optimization, which may tend to be complicated in particular, is based on Miller-Tucker-Zemlin (MTZ) formulation, it is possible to achieve both constraint flexibility and calculation speed. Specifically, the loading plan creation unit 40 allows the user US to generally independently make selection of below-described various additional constraints. In other words, the user US can add or remove constraints for the delivery plan as options. In addition, calculation speed reduction when the constraint is added can be significantly less than when solution methods such as allocation and approximate solution method are used.

In particular, MIP (Mixed Integer Programming, Mixed Integer Programming problem) solver with dominated “conditional linear constraint” is used in the MTZ formulation in the delivery plan optimization process. The MTZ formulation has been recognized as a low-speed method. But when the MIP solver able to implement the conditional linear constraint with low load (hereafter referred to as “new solver”) is used, it becomes easier to achieve both high flexibility in constraint and calculation speed. The conditional linear constraint is such a constraint as “ only when binary variable A=1, integer variable X<integer variable Y”. Examples of the new solver include CP-SAT solver (CP-SAT type solver) of OR-Tools provided by Google. Benefits of combining MTZ formulation with CP-SAT type solver include facilitating implementation of additional constraints, ensuring a wider range of implementable additional constraint and suppressing a calculation amount increase. It is also possible to add and remove the constraints from the user point of view, and to reduce the calculation amount for the removed constraints.

### Description of Terms

Now, terms used in the below description are defined, including package, pool, capacity, task, job, input data, and output data.

The package is one of items of the input information to the optimization unit 50 and the delivery plan creation unit 30. The package is the smallest unit of a delivery request. The packages are allocated to a small number of tasks from a pool where one or more packages are collected. Each package has tag information for identification (number and shipper information, etc.), departure location, arrival location, loading time window, unloading time window, etc. There are following inclusion relationships: the pool is a proper subset of the task; the task is a proper subset of the package; and the task is a proper subset of the job. The package type and package category include refrigeration required, chemicals, fragile, etc.

The pool is an intermediate unit of the delivery request used in the delivery plan. The pool is automatically created in a pre-process of the delivery plan optimization based on the package information. As described below, the number of pools, pool capacity, information linking the pool to the departure and arrival locations, and information linking the pool to the time window are set separately.

The capacity is an approximate loadable amount used in the delivery plan and is expressed in percentage %. The capacity is determined in the pre-process with reference to a dominant factor of the loading limit from among dimensions, volume, weight of the package included or possibly included in a task. If there are two or more tasks with the same departure and arrival locations, there happens a package that can be included in any one of the tasks, and these tasks will have variable capacity for that package. However, the total capacity is basically constant (pool capacity). In this case, for each task, the capacity is defined in terms of a corresponding pool and a pool capacity.

The task is an intermediate unit of the delivery request used in the delivery plan. The task is automatically created in the pre-process of the delivery plan optimization based on the pool information. As described below, the number of tasks, the information linking the task to the time window, the information linking the task to the pool number and the like are set. The information linking the task to the departure and arrival locations can be the same as the information linking the pool and the departure and arrival locations. It is necessary to set the information linking the task and the time window to values different from those of the pool at the time of the pre-process if the customer requires equal-interval deliveries.

The job is an intermediate constant created based on the task information. Basically, one task=one job. However, when the below-described relay plan is implemented, an additional pre-process is performed to divide the long-distance task into multiple jobs (hereinafter referred to as “small section jobs”). As described below, the number of jobs, information linking the job to the task, information linking the job to the departure and arrival locations, information linking the job to the time window, information linking the job to the pool capacity, information linking the job to the pool number and the like are set as appropriate. The information linking the package to the pool and the information linking the task to the job described so far is fixed (constant) at an input stage. The information linking the package to the task has not been determined (variable) at the input stage. As a general rule, when a long-distance task is split for delivery, the task is split into one or more small section jobs. For example, a task is for a large section and a job is for a small section.

The input data refers to one set of input constant information to the optimization unit 50 corresponding to one optimization calculation. Similarly, the output data refers to one set of output variable information from the optimization unit 50 corresponding to one optimization calculation. The calculated logistics plan as a whole is unreadable from the output data alone. The logistics plan as a whole becomes interpretable by matching the input data and the output data having one-to-one correspondence with each other.

### Details of Platform Unit

The platform unit 10 illustrated in FIG. 1 and FIGS. 3 to 5 enables use of real time partial correction of the delivery plan and the loading plan with a practical response time, by utilizing asynchronous communications. The platform unit 10 enables the following three points via an automated data creation function and a complementation function group. A first function is such that the platform unit 10 extracts and combines portions of a vast amount of raw data shared by multiple entities while resolving discrepancy among them and makes them available. A second function is such that the platform unit 10 converts data of significantly different data formats to make them available. For example, the current schedule information is converted to the package information and the base-to-base information, etc. In addition, the platform unit 10 creates and makes available a large amount of virtual data with only part of the setting changed.

In addition, the platform unit 10 enables adjustment of detailed setting of optimization that depends on the input data via a visualization function and an edit function. This makes it possible to fine-tune the output schedule immediately via a database 70 and an asynchronous communication function group. The platform unit 10 enables mutual communication and data exchange between the users US, simultaneous editing of the input/output data by multiple people, and optimization of partial correction and schedule editing based on a real-time delivery actual result.

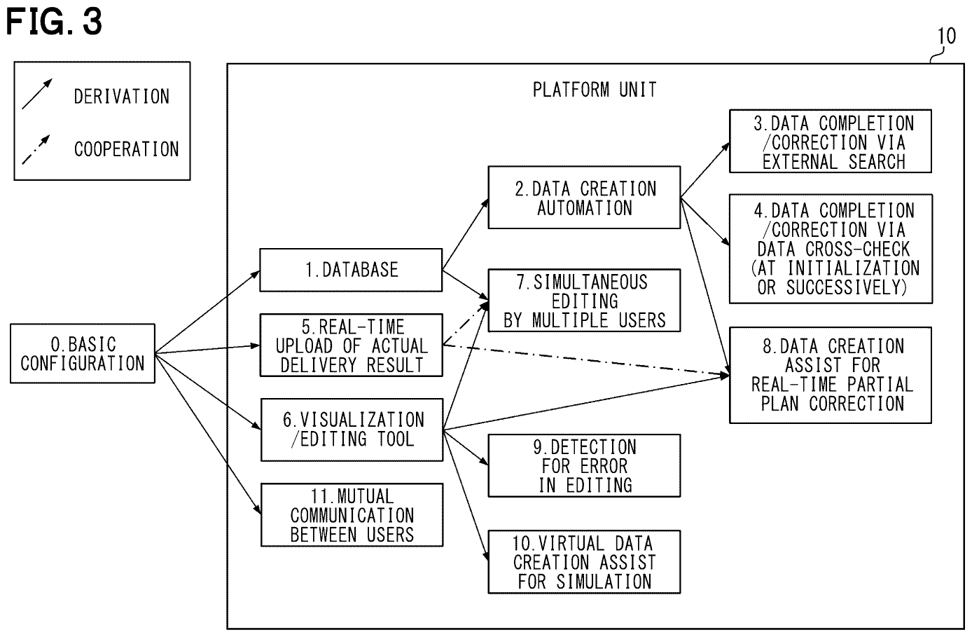

The platform unit 10 includes multiple functional units derived from a basic configuration, as illustrated in FIG. 3. Man-hours reduction, risk reduction, and versatility are achieved via the multiple functional units of the platform unit 10. The man-hour reduction is to enable the user US to complete the desired operation in a shorter time by improving convenience, although handleable use cases remain the same. The risk reduction is to reduce a risk of using wrong data due to human error, although handleable use cases remain the same. The versatility is to enable a not-handleable use case to be handleable. In the below, details of the multiple functional units implemented in the platform unit 10 will be described in order.

### 1. Database

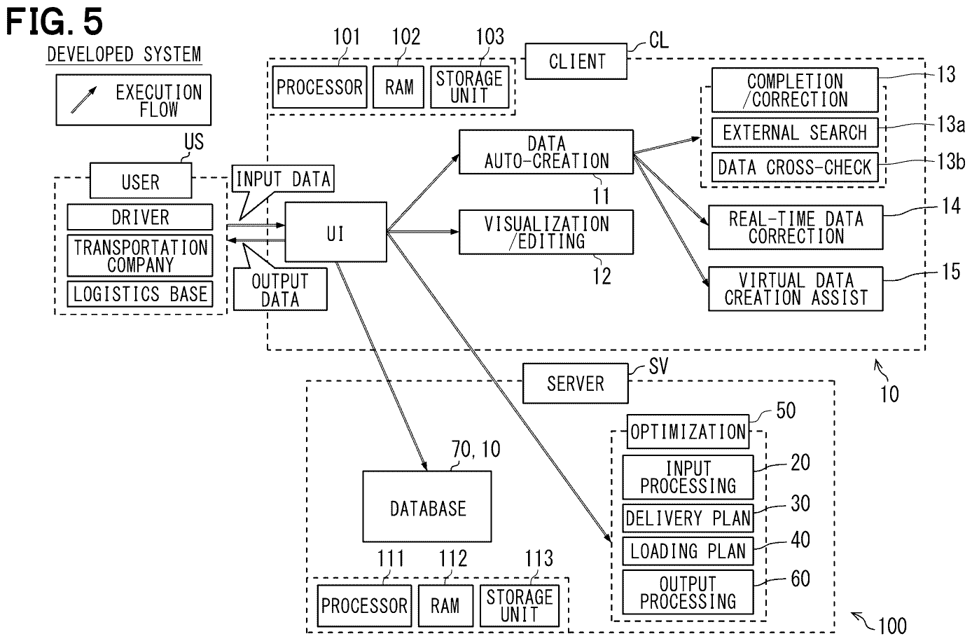

The platform unit 10 prepares a database 70 in the server SV (see FIG. 5). Multiple user US are permitted to store and retrieve the input/output data using the database 70 as they like. In addition, each user US can use the database 70 for calculation. Because of the database 70, even when data provider and data user are different or data providing time period or data use time period are different, data exchange and storage management are unnecessary. As a result, convenience is improved and, and consequently, man-hours can be reduced.

### 2. Data Creation Automation

By designation of a data extraction condition, the platform unit 10 extracts and combines portions that match the condition from an original data in the database 70 to create the input data. The platform unit 10 converts the current schedule information into an output data format or converts the current schedule information into input data and an optimization setting format. In this way, the platform unit 10 converts data, which is not data of a standard format, stored in the database into the standard format by using a logic that includes analogical reasoning. These automation functions reduce the man-hours.

The data extraction function is necessitated when there is a huge amount of raw data and only a portion of it needs to be extracted to create input data. A data connection function is necessitated when data provided by different entities are linked to each other to create input data. For example, in cases of use with separate chains of command, a transportation company inputs the base-to-base information, a warehouse company inputs the base capability information, and the customer inputs the package information. According to a study for efficiency improvement by area integration among multiple companies, a transportation company A inputs part of the package information and a transportation company B inputs part of the package information.

### 3. Data Complementation and Correction by External Search

The platform unit 10 automatically performs search when there is missing or omission in the automated creation of the input data and external information outside the database 70 is available. The platform unit 10 can increase a range of available data via automated search of the external information. For example, a process of converting an address into a latitude and a longitude and a process of calculating a distance from the latitude and the longitude may be performed. Because of this, usable data is obtained from partially missing and omitted data, improving versatility.

### 4. Data Complementation and Correction via Data Cross-Check

If there is missing or omission in the automated creation of the input data, the platform unit 10 performs complementation by using the data in the database 70 such that the data is complemented with the data of the same format in the database 70. When the data cannot be complemented with the data of the same format, the platform unit 10 performs complementation by analogical reasoning such that the data is complemented with the data of a different format in the database 70.

For example, if the base-to-base information for a certain base is absent, the platform unit 10 uses information for a base that has the same latitude and longitude or the same address. If the information is still insufficient, the platform unit 10 searches for a shortest route by combining paths on condition that path information in smaller units is available.

If there is a discrepancy in the data in the automated creation of input data, the platform unit 10 automatically corrects the discrepancy by using a correction logic prepared in advance. For example, when the time frames designated for the packages currently delivered with a task A and a task B are “20: 00 to 25:00” and “0:00 to 5:00”, the platform unit 10 corrects the time frame for the task B into “24:00 to 29:00”. By the above, data with missing or omission is changed into usable data, improving versatility. The platform unit 10 also includes, as its logic, error detection immediately after the automated creation of data in order to resolve data discrepancy. This reduces human error risk. The platform unit 10 performs data complementation and correction at initialization or successively.

### 5. Real-Time Upload of Delivery Actual Result

The platform unit 10 enables real-time sharing of current locations and delivery actual results by respective vehicles and drivers. The platform unit 10 can display information on the current locations and the delivery actual results on a terminal of each user US via asynchronous communication in an up-to-date manner. This makes it possible to ascertain in real time whether or not the created logistics plan is normally in execution.

In addition, the platform unit 10 enables not only an overall view of the latest status of plan execution but also real-time plan correction via use of a cooperating plan creation tool. That is, the platform unit 10 can newly provide a tool equipped with optimization AI for plan creation having a real-time sharing function.

### 6. Visualization and Editing Tool

The platform unit 10 provides an edit tool for visualization and editing of the input/output data, so that detailed editing of input parameters for optimization and fine tune of the schedule can be performed. The input data can be input via direct input or automated input based on condition designation. One set of input data is four data items for one optimization calculation. The four data items are the package information, the base information, the base-to-base information, and the general parameters. The output data is data that is output through the optimization unit 50 and stored in the database 70. One set of the output data is two data items, which are the schedule information and the cargo configuration information.

Via the function of visualizing the input/output data, the platform unit 10 creates a KPI table, a Gantt chart, an abstract flow diagram, a flow animation, a 3D cargo configuration, and a cargo handling order animation. KPI is abbreviation for Key Performance Indicator. Because of this, an individual planning requirement unreadable from the original data is incorporated in a form of editing to the input data. For example, a requirement “loading the package A started at 14:00 in the past actual results, but in the next plan, please start at between 15:00 and 16:00.” can be incorporated into the setting via reading of past data and editing of the input items.

If the output data automatically created by the optimization unit 50 includes a counterintuitive part, the user US can immediately make fine adjustment without using external tools. This can reduce man-hours. The platform unit 10 can perform conversion from the schedule to a diagram/chart at any timing, making it possible for user US to “make fine adjustment to the schedule and additionally check the KPI and trends each time”.

### 7. Simultaneous Editing by Multiple Users

The platform unit 10 enables simultaneous editing of the schedule information and other information on the user interfaces of multiple users US via asynchronous communication. The simultaneous editing function for multiple persons is a function cooperating with the above-described [5. Real-Time Upload of Delivery Actual Result]. The platform unit 10 enables multiple people to work simultaneously while sharing the same screen in situations where fine tune of the plan is required. This can reduce the man-hours required for correction work. In addition, those including local drivers are allowed to edit at the same time for real time correction of the plan. As a result, two correction methods are provided: one is to correct the plan by directly editing the output schedule information; and the other is to correct the input information and start over from the optimization.

### 8. Data Creation Assist for Real-Time Partial Plan Correction

The platform unit 10 creates the input data for the optimization in which only confirmed part of the day's schedule (task and package, task and clock time, task and driver, task and vehicle, etc.) is fixed and the rest of the schedule is open. This data creation assist function is a function cooperating with the above-described [5. Real-Time Upload of Delivery Actual Result]. The platform unit 10 can perform the optimization process of partially correcting the created plan by using the same optimization program as in normal operation and can easily perform plan correction in real time. In addition, if real-time sharing of delivery actual results is already implemented, use of the most recent delivery actual results leads to improvement in effective response time.

For example, the plan correction is facilitated in the following cases: a case where deviation from the expectation from the original plan happens during execution of the delivery plan; a case where the delivery actual result up to now deviates from a predicted result; and a case where a traveling time is predicted to deviate from that in the original plan due to a climate change or a traffic jam condition. In particular, in cases where the deviation is too large to be absorbed by manual schedule editing, the optimization function for partial correction is useful in cost reduction.

### 9. Error Detection in Editing

The platform unit 10 detects errors including a discrepancy that occurs in the process of user US manual editing of the input/output data. At a time of error detection, the platform unit 10 notifies the user statically or dynamically about warnings of detected errors. The platform unit 10 reduces human error risk via an error detection and error warning function.

If the platform unit 10 detects an error at a time when a value is entered into the data, the platform unit 10 displays a warning immediately. The platform unit 10 may also display a warning on a confirmation screen immediately prior to execution of data storage and optimization. Example of the error include the designated time frame that has a start time later than an end time (e.g., 5:00 to 2:00), and the package information that has the departure or arrival location not registered as the base. This prevents the risk of not-calculatable calculation and the risk of infeasible schedule output.

### 10. Virtual Data Creation Assist for Simulation

The platform unit 10 provides an auxiliary function for creating virtual data different from the current existing state, for the purpose of logistics robustness evaluation and new base construction feasibility. The platform unit 10 can create a group of package information with appropriate probability distribution in terms of quantity, shape, classification, weight, and time frame designation by analogy from other data, based on, for example, the newly introduced flow line and logistics scale designation. The platform unit 10 can enumerate the coordinates of candidate sites based on distances from other sites, land value, topography, and purchase availability by designating areas for new base construction review and target package information.

The system is usable in respect of which case is the best for increasing the number of bases and requests. This differs from a system that plans low-cost logistics based on already existing bases and requests. As a result, a use range can be expanded. Furthermore, with these auxiliary functions, cost reductions can be achieved with fewer man-hours.

### 11. Mutual Communication Between Users

The platform unit 10 provides a function for communication of various data between users US via the server SV, the various data including the original data and the input/output data, as well as other additional information such as comments and messages. The platform unit 10 facilitates conveying information between users US and enables communications without external tools. This reduces man-hours and prevents confusion with respect to chains of command.

### Details of Platform Unit of Basic System

The logistics plan system 100 illustrated in FIG. 4 is provided by a client terminal CT and the server SV. The client terminal CT is a computer, a mobile terminal (smartphones and tablets), etc., for using network-based services. The client terminal CT includes a computational processing circuit including a processor 101, a RAM 102, and a storage unit 103. The client terminal CT executes the logistics planning program stored in the storage unit 103 by the processor 101 coupled with the RAM 102. In this way, the client terminal CT provides the user US with the user interface given by the platform unit 10.

The server SV is communicably connected to the client terminal CT of each user US through the network. The server SV may be an on-premise physical configuration managed by a service provider of the logistics planning system 100 or may be a virtual configuration on the cloud. The server SV includes a high-performance computational processing circuit, including a processor 111, a RAM 112, and a memory 113. The server SV executes the logistics planning program stored in the storage unit 103 by the processor 101 coupled with the RAM 102. Functional units implemented in the server SV by execution of the logistics planning program include an input processing unit 20, a delivery plan creation unit 30, a loading plan creation unit 40, and an output processing unit 60. The input processing unit 20, the delivery plan creation unit 30, the loading plan creation unit 40, and the output processing unit 60 function as the optimization unit 50. When the server SV executes the logistics planning program, a logistics planning method is executed.

In the logistics planning system 100 employing the platform unit 10 of the basic system described so far, one complete set of the input data is prepared entirely by the user US. The users US are, for example, workers belonging to a transportation company, a logistics base, etc. The user US inputs the input data into the user interface provided by the client terminal CT. The client terminal CT transmits the input data for one optimization to the server SV. The client terminal CT receives the output data optimized at the optimization unit 50 from the server SV. The client terminal CT presents the received output data to the user US using the user interface.

### Details of the Platform Unit of the Developed System

The logistics planning system 100 illustrated in FIG. 5 employs the platform unit 10 of the developed system. The platform unit 10 of the developed system enables data storage, communication between users US, data visualization, automated data creation and processing, and manual data creation and processing. This enables detailed data-dependent setting to be reflected in the optimization.

The user interface provided by the client terminal CT is used by the user US to input raw data, actual result information, and input data similar to those in the basic system. Examples of the user US may include a driver in addition to the worker belonging to the transportation company, the logistics base, etc. The user interface presents the input data, the output data, and the actual result information to the user US.

Functional units of the client terminal CT related to the platform unit 10 include a data auto-creation unit 11, a visualization editing unit 12, a complementation correction unit 13, a real-time data correction unit 14, and a virtual data creation assist unit 15.

The data auto-creation unit 11 is a functional unit that provides the above described [2. Data Creation Automation]. The raw data, the actual result information, and/or the input data input into the user interface is transmitted to the data auto-creation unit 11. From the data auto-creation unit 11, the user interface receives the input data created by the data auto-creation unit 11.

The visualization editing unit 12 is a functional unit that provides the above-described [6. Visualization and Editing Tool]. The input/output data before editing is provided from the user interface to the visualization editing unit 12. The visualization editing unit 12 enables multiple people to edit data at the same time and provides the data error detection function. From the visualization editing unit 12, the user interface receives the input/output data after editing and a visualization diagram/chart group created by the visualization editing unit 12.

The complementation correction unit 13 is a functional unit that provides the above-described [4. Data Complementation and Correction via Data Cross-Check]. Incomplete input data is transmitted from the data auto-creation unit 11 to the complementation correction unit 13. The complementation correction unit 13 includes sub-function units such as an external search unit 13a and a data cross-checking unit 13b. The complementation correction unit 13 creates complete input data by complementing and correcting the incomplete input data. The complementation correction unit 13 provides the complete input data to the data auto-creation unit 11.

The real-time data correction unit 14 is a functional unit that provides the above-described [8. Data Creation Assist for Real-Time Partial Plan Correction]. The input data is transmitted from the data auto-creation unit 11 to the real-time data correction unit 14. The real-time data correction unit 14 creates the input data including the fixed part based on the actual result and road conditions. The real-time data correction unit 14 provides the created input data to the data auto-creation unit 11.

The virtual data creation assist unit 15 is a functional unit that provides the above-described [10. Virtual Data Creation Assist for Simulation]. The input data is transmitted from the data auto-creation unit 11 to the virtual data creation assist unit 15. The virtual data creation assist unit 15 creates input data in which part of bases and packages are added to virtual information or replaced. The virtual data creation assist unit 15 provides the created input data to the data auto-creation unit 11.

The server SV includes the database 70, in addition to the input processing unit 20, the delivery plan creation unit 30, the loading plan creation unit 40, and the output processing unit 60 which function as the optimization unit 50. The database 70 is a configuration of the platform unit 10 that provides the above described [1. Database] in the server SV. Various information is exchanged between the user interface and the database 70, including the input data, the output data, the delivery actual result, the road conditions, and messages between users US. The user interface also transmits the input data to the optimization unit 50. The user interface receives the output data from the optimization unit 50.

### Details of Input Processing Unit

The input processing unit 20 illustrated in FIG. 1 and FIGS. 6 to 8 uses clustering to extract an area where manual selection is difficult and automates an execution flow of the extraction and optimization. In addition, the input processing unit 20 uses multiple machines in parallel to speed up continuous execution and guarantee a minimum response time for some functions. Furthermore, by an auto-save function, the input processing unit 20 can avoid an interruption risk during execution of multiple optimizations that have, in part or as a whole, a serial-structured execution flow where a result of the previous processing is used in the later processing.

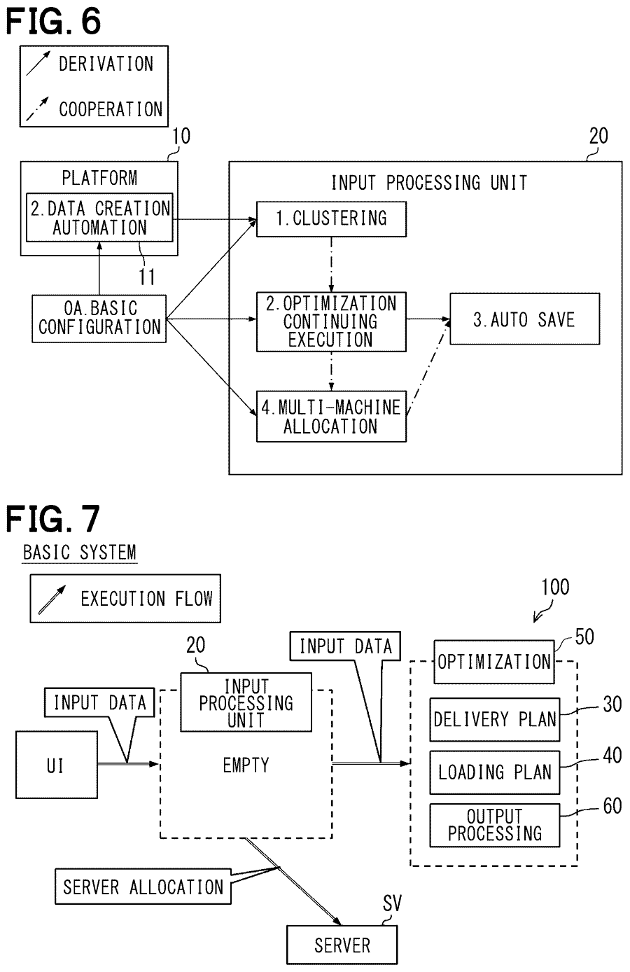

The input processing unit 20 includes functional units derived from the basic configuration and the platform unit 10, as illustrated in FIG. 6. The multiple functional units in the input processing unit 20 will be described in detail in turn.

### 1. Clustering

The input processing unit 20 utilizes the functionality of the data auto-creation unit 11 of the platform unit 10 able to create the input data simply by designation of the extraction condition and executes an optimization program for a pre-process for finding a useful extraction condition. By incorporating the clustering program into the pre-process in the input processing unit 20, it is possible to optimize a partial area even in situations where the user US cannot determine an appropriate extraction condition. The area is a group of data divided according to location, task, and flow line, etc.

The input processing unit 20 performs clustering with reference to the distance between the bases and the distance between delivery destinations, so that it is possible to suppress the number of bases while the number of jobs and the capacity average value are kept constant. In addition, clustering is performed in unit of multiple jobs (unit≈a set of jobs indivisible) for which the same sales office or company is responsible. The input processing unit 20 can selectively use any of different types of clustering depending on situations: drafting for overall optimization (all-case clustering); and clustering to find the area that is well compatible with the designated area (related clustering).

According to the clustering described above, it is possible to create the data extraction condition by using the mathematical optimization to comprehensively determine the compatibility between the areas that is not determinable without looking across multiple information in different formats. This leads to reduction in man-hours and enables condition selection with higher accuracy than manual selection.

### 2. Optimization Continuing Execution

The input processing unit 20 automatically and continuingly executes multiple optimizations using respective inputs based on the designated condition. Addition of this function reduces man-hours for large-scale use. By cooperating [2. Optimization Continuing Execution] and [1. Clustering] with each other, the input processing unit 20 enables such use that “based on multiple clusters found on the condition of not overlapping at all or not overlapping in part, the optimization is executed continuingly.

For example, in a first use case, a pseudo-overall optimization (all-case clustering) is executed by dividing a large area into multiple not-overlapping clusters and optimizing each one. In a second use case, a search for integration candidate areas around a target area (related clustering) is executed by optimizing each using multiple clusters that include a certain area without a complete overlap relationship nor a complete inclusion relationship.

The input processing unit 20 described above automates iterative execution of optimization which is totaling one hour or more and which is difficult to execute manually. As a result, the man-hours can be reduced. In particular, in combination with the clustering, it is possible to automatically identify the areas compatible with each other and perform the pseudo-overall optimization.

### 3. Auto Save

When optimization and clustering are performed multiple times in series or in parallel, the input processing unit 20 automatically stores an intermediate result in the database 70 each time a respective optimization calculation is ended, in particular when input/outputs are not in independent of each other. Even after interruption due to user US decision or unexpected error, this auto-save function enables the input processing unit 20 to resume the optimization from the middle at the next startup.

The input processing unit 20 can cooperate the function [3. Auto Save] with the function [4. Multiple machine allocation]. When the function of [4. Multiple machine allocation] is implemented, the multiple optimizations are allocated to multiple machines in parallel, and the save is performed at a central node upon end of each calculation. Thus, in cases of absence of the input/output independency, the input processing unit 20 saves the intermediate data by dynamical determination or by performing a synchronization process between the servers SV in specific pre-fixed timing. According to the input processing unit 20 described above, it is possible to reduce the risk of interruption during large-scale use including multiple runs of optimization and to reduce man-hours and prevent large-scale deterioration of effective response time due to errors.

### 4. Multiple Machine Allocation

The input processing unit 20 prepares multiple machines (servers SV) and leaves part of the machines open for emergency plan correction, so that the plan correction at a processing speed above a certain level is ensured all times. The input processing unit 20 cooperates the [2. Optimization Continuing Execution] with [4. Multiple Machine Allocation] so that multiple optimizations independent of each other are not serially run at a single machine but are allocated to separate computers, whereby effective processing speed is improved. Because of this, the plan correction at a processing speed above a certain level is ensured all times, resulting in a robust system with a response time not fluctuating wildly. In addition, the combination with the continuing execution function improves a response time and increases the number of users during large-scale use, thereby improving convenience.

### Details of Input Processing Unit of Basic System

The logistics planning system 100, in which the input processing unit 20 of the basic system illustrated in FIG. 7 is employed, accepts only input data of one case (for one case) in a normal format from the user interface. The input processing unit 20 provides the accepted input data of one case to the optimization unit 50 as it is. In this logistics planning system 100, only one server SV is used.

### Details of Input Processing Unit of Developed System

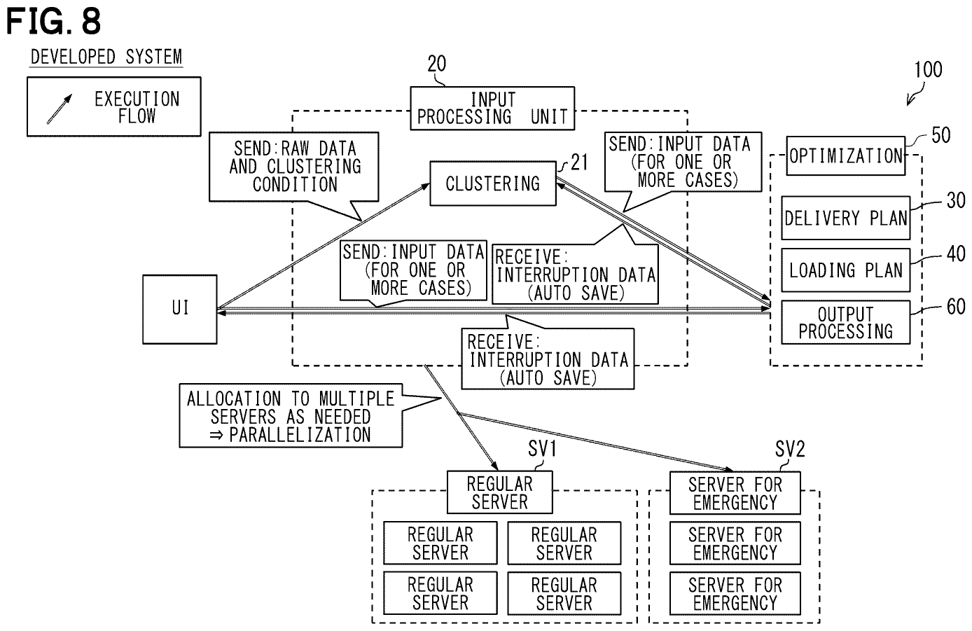

The logistics planning system 100 illustrated in FIG. 8 employs the input processing unit 20 of the developed system. In this logistics planning system 100, depending on the type of command received, the system selectively uses different processes depending on situations: the input data is optimized as it is; and the input data is created according to the command and then optimized. When the input data is optimized as it is, the input data for one or more cases is transmitted from the user interface to the optimization unit 50.

When the input data is created according to the command, the clustering unit 21 of the input processing unit 20 is used. The clustering unit 21 is a functional unit that implements the above-described [1. Clustering]. The raw data and the clustering condition are transmitted to the clustering unit 21 from the user interface. The clustering unit 21 creates the input data according to the clustering condition and transmits the created input data for one or more cases to the optimization unit 50.

When the input processing unit 20 receives interruption data from the optimization unit 50, the input processing unit 20 saves the received interruption data using the auto-save function, regardless of whether the input data is optimized as it is or the input data is created according to the command and then optimized.

By distinguishing between an emergency server SV2 and other normal server SV1, the input processing unit 20 achieves speedup by using multiple machines in parallel while ensuring a minimum response speed. The input processing unit 20 allocates the process to the emergency server SV2 only when a stable response time is required.

### Details of Delivery Plan Creation Unit

The delivery plan creation unit 30 (delivery plan optimization unit 30a) illustrated in FIG. 1 and FIGS. 9 to 19 enables the following three points. As a first function, the delivery plan creation unit 30 supports selective execution depending on status setting of the vehicle and the office it belongs to (departure location). As a second function, the delivery plan creation unit 30 supports selective execution depending on delivery rules such as labor constraints, refueling, charging, and separation. Furthermore, as a third function, the delivery plan creation unit 30 can switch between a fast milk-run logistics plan and a high-flexibility relay logistics plan by changing job interpretation. The delivery plan creation unit 30 defines a job as a unit linked to a delivery request used in the delivery plan and creates the delivery plan with variable job capacity.

The delivery plan creation unit 30 creates the delivery plan by applying a user-designated constraint based on the option information. The option information is information that indicates setting of the constraint to be applied to the delivery plan. The user US can select (add or remove) an additional constraint by switching parameters on and off, as he/she likes. As a result, the logistics planning system 100 ensures flexibility in constraint and objective function.

The constraints in the delivery plan creation unit 30 include: standard VRPTW; maximum working time; time window for each job or base; single base; no stopovers on the way to a base; capacity limit for each vehicle; variable relationship between the task and the capacity; and variable relationship between the task and the cargo handling time. In addition to these constraints of the basic system, the delivery plan creation unit 30 is applied with an objective function for minimizing the number of vehicles or the working time.

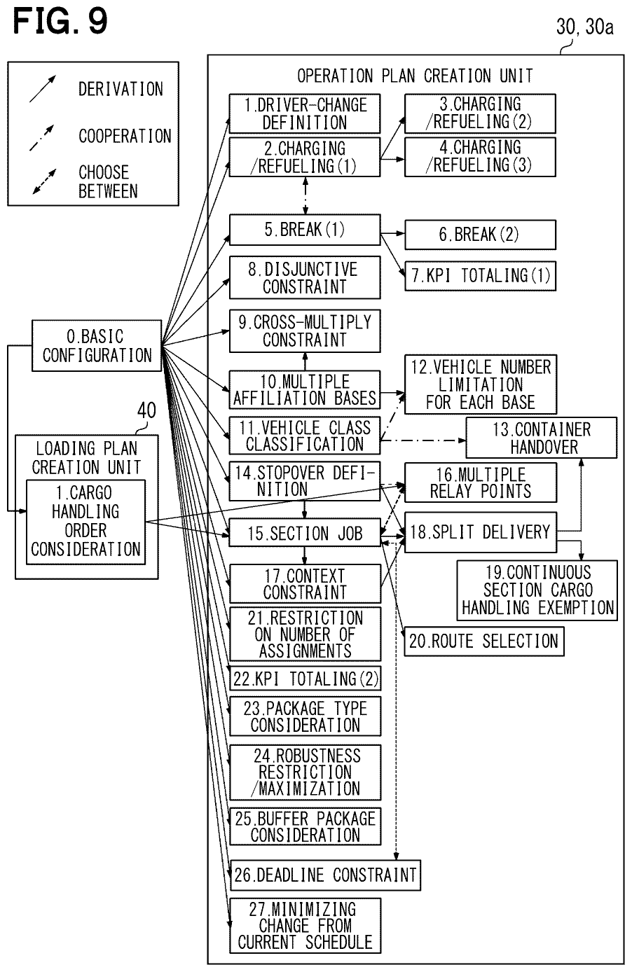

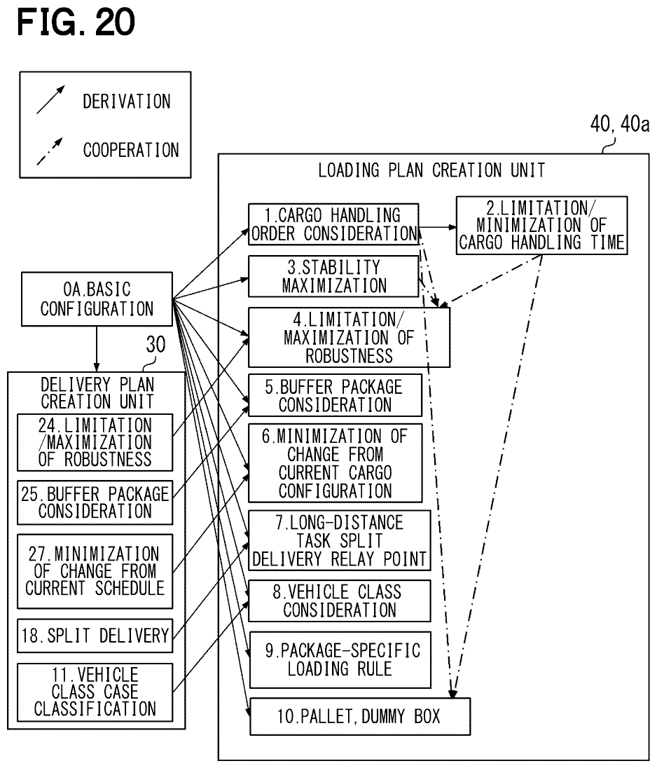

The delivery plan creation unit 30 includes functional units derived from the basic configuration and the loading plan creation unit 40 (see 1. Cargo Handling Order Consideration, FIG. 20 below), as illustrated in FIG. 9. The delivery plan creation unit 30 uses multiple functional units to achieve speedup, accuracy improvement, adequacy improvement, and versatility. The speedup is to solve the same problem faster, although a range of solvable problems remains the same. The accuracy improvement is to improve an optimal solution while keeping the constraints unchanged, by taking into account excessive part of the constraints, although a range of solvable problems remains the same. The adequacy improvement is to find an optimal solution more conforming to actual circumstance, by taking into account a shortage (not indispensable but worth considering) of the constraints, although a range of solvable problems remains the same. The versatility is to enable a not-handleable problem to be handleable. The multiple functional units implemented in the delivery plan creation unit 30 will be described in detail in turn.

### 1. Driver-Change Definition

The delivery plan creation unit 30 divides a vehicle edge variable into two types which are an occupant edge type and a vehicle edge type and divides a vehicle use time variable into two types which are a vehicle use time type and an occupant working time type, so that an exception handling (driver change) for use of a single vehicle by multiple occupants is available. By using the driver change, the number of vehicles and cargo handling time can be saved. As a result, accuracy improvement is achieved. The vehicle edge means “whether the same single vehicle is continuingly responsible to job i”. The exception handling (driver change) enables the use of a single vehicle while changing drivers in a single task.

### 2. Charging and Refueling (1)

The delivery plan creation unit 30 defines the following four variables. A first variable is a margin time variable for each job and job connection. A second variable is availability of charging/refueling after visit (job) to each base. A third variable is a time length of charging/refueling after each job. A fourth variable is a remaining level of the battery/fuel after each job. The delivery plan creation unit 30 links these four variables in an order from the first to the fourth and formulates a constraint that the remaining level of the battery/fuel is not negative at the time of each job and at the end of the operation. In this way, charging and refueling are taken into account for long-distance deliveries that require refueling and charging in the middle of the operation. As a result, adequacy is improved.

### 3. Charging and Refueling (2)

The delivery plan creation unit 30 creates the delivery plan corresponding to the traveling time and the charging/refueling time which are settable by the user US as he/she likes. In creating the delivery plan, the delivery plan creation unit 30 takes into account such a tendency that an electric power consumption and electric power charging coefficient per travel and per charging time are nonlinearly variable depending on remaining battery levels at respective time points. The consumption coefficient depends on travel distance and speed. Prepared in the delivery plan creation unit 30 are two charging reference data (dictionary data) as a function of the remaining battery level of the battery for traveling mounted to the vehicle and its duration. A first charging reference data is two-dimensional data (matric information) that shows a nonlinear consumption coefficient as a function of the remaining battery level and the duration. A second charging reference data is two-dimensional data (matric information) that shows a nonlinear charging coefficient as a function of the remaining battery level and the duration.

For example, when the remaining level of the battery for traveling is at or near maximum (full), the charging coefficient may drop to ¼ of the maximum coefficient. In addition, if the battery for traveling is used at or near the maximum (full) remaining level, the life of the battery for traveling can be reduced. To reflect these preconditions, the delivery plan creation unit 30 takes into account the traveling time and charging time set by the user US with reference to the reference data on the consumption coefficient and the charging coefficient. Specifically, by using the two-dimensional reference data with the remaining battery level and the duration, the delivery plan creation unit 30 calculates the remaining battery level after the charging based on the remaining battery level and the charging time and calculates the remaining battery level after the travel based the remaining battery level and the traveling time. In this way, the delivery plan creation unit 30 creates the delivery plan taking into account the charging time of the battery for traveling at each charging point, e.g., “battery is occasionally charged only for its use”.

The delivery plan creation unit 30 performs linear relaxation on nonlinear charging and consumption coefficient functions and performs formulation to include, for example, such a conditional branch that “if the remaining battery level is in a range from NN to NN %, charging/consumption per unit time is NN %”. As compared with using linear charging and consumption coefficients, the delivery plan creation unit 30 can develop a charging plan more conforming to the actual situation and creates an efficient delivery plan conforming to the actual situation by preventing shortages and excesses in the charging plan. The delivery plan creation unit 30 can improve adequacy by using mathematical optimization to create the delivery plan taking into account the non-linear charging coefficient.

Furthermore, the delivery plan creation unit 30 may be able to take into account the load on the battery for traveling and develop a delivery plan that minimizes the battery load. Specifically, the delivery plan creation unit 30 defines the battery load as the duration of the state in which the remaining level of the battery for traveling exceeds a given upper limit or falls below a given lower limit and sets a penalty according to this battery load. The delivery plan creation unit 30 develops a delivery plan so as to minimize the battery load as the penalty.

The delivery plan creation unit 30 can also take into account the remaining fuel level, similarly to the remaining battery level. The delivery plan creation unit 30 takes into account such tendency that fuel consumption and refueling coefficients per travel and per refueling are nonlinearly variable depending on the remaining fuel levels at respective time points. Specifically, the delivery plan creation unit 30 is provided with two refueling reference data (dictionary data) that show a nonlinear relationship between the remaining level of fuel in the fuel tank mounted to the vehicle and its duration. A first refueling reference data is two-dimensional data showing the consumption coefficient as a function of the remaining fuel level in the fuel tank and the duration. A second refueling reference data is two-dimensional data showing the refueling coefficient as a function of the remaining fuel level in the fuel tank and the duration. With reference to the refueling reference data, the delivery plan creation unit 30 calculates the refueling time, and creates the delivery plan taking into account the refueling time at the refueling point. Furthermore, the delivery plan creation unit 30 can also take into account the circumstances on charging and refueling-related facilities, such as the distribution, the number, and type of charging/refueling facilities at bases, sales offices, on the road, etc.

### 4. Charging and Refueling (3)

The delivery plan creation unit 30 uses an interval variable which is an extension of the CP-SAT type solver to define a conditional interval variable indicating “whether or not a job i occupied a facility k at base j, and if so, from what time to what time it was used. In this way, the delivery plan creation unit 30 takes into account vehicle allocation for charging facilities and refueling facilities at respective bases and time frames. This avoids the risk of making the plan infeasible due to allocation of excessive vehicles to a base not having sufficient facilities. In addition, extensions in some CP-SAT type solvers can be used by lighter weight implementations.

### 5. Break (1)

The delivery plan creation unit 30 defines the following five variables A first variable is a margin time variable for each job and job connection. A second variable is availability of break after each base visit (job). A third variable is a break length after each job. A fourth variable is a continuous no-break handle time at each job point. A fifth variable is a cumulative brake time at a time after each job. The delivery plan creation unit 30 links these variables and formulates two constraints: the continuous no-break handling time at each job and at arrival does not exceed a specified value; and the cumulative break time at the end of the job is greater than or equal to a specified value.

The above enables the delivery plan creation unit 30 to take into account labor constraints such as minimum break threshold, obligation to take breaks, and continuous operating time constraint. The minimum break threshold is, for example, such that “each break should be at least NN minutes”. The obligation to take breaks is, for example, such that “only if the working time exceeds NN minutes, the total break time before the end of the work is at least NN minutes” The continuous operating time constraint is such that “at most, continuous working without a break should not exceed NN minutes.”

When [2. Charging and Refueling (1)] is linked to [5. Break (1)], the delivery plan creation unit 30 variablizes allocation as to how long the margin time is allocated to any of the break and the charging/refueling. This enables the delivery plan creation unit 30 to develop a delivery plan that meets at least legal requirements on continuous operating hours and the obligation to take a 60-minute break during a long work, and to create truck delivery plans useful in the field.

### 6. Break (2)

The delivery plan creation unit 30 newly defines two variables. A first variable is a variable indicating whether, in a case of taking a break after each job, it is possible to take the break later than the point corresponding to NN % of the working time. A second variable is a variable indicating whether, in a case of taking a break after each job, it is possible to take the break later than the point corresponding to NN % of the working time. The delivery plan creation unit 30 links these variables to the departure clock time and the working time of the driver and formulates such constraint that, if the two conditions are both met, the driver is allowed to take the break, whereby eccentric distribution of break times is eliminated. In this way, together with the continuous handling time constraint, it is possible to eliminate workload caused by the driver break time being unevenly distributed in the early or late phases of the operation.

### 7. KPI Totaling (1)

The delivery plan creation unit 30 develops a delivery plan that takes into account: indicators KPI related to labor responsibility, environmental responsibility, etc. ; and economic responsibility (fees paid). The labor circumstances include a ratio of a travel distance with the load to a total travel distance, a ratio of actual load to maximum load capacity multiplied by a travel distance, a ratio of a travel distance without load to a total travel distance, and a package waiting time. In the delivery plan creation unit 30, all KPIs as defined by regulations may be designated as objective functions. The delivery plan creation unit 30 defines a job as a unit linked to a delivery request used in the delivery plan. The delivery plan creation unit 30 totals indicators KPIs of multiple types related to the drivers and vehicles linked to the jobs and fees of multiple types paid to the drivers and vehicles linked to the jobs. The delivery plan creation unit 30 creates a delivery plan optimizing the indicators KPIs of multiple types and the fees of multiple types.

The delivery plan creation unit 30 can total the fees of multiple types (base salary, overtime allowance, night allowance, and vehicle expenses) incurred for the drivers and vehicles. Therefore, the delivery plan creation unit 30 newly defines four variables based on the working time of the driver and vehicle responsible for each job. A first variable is a base time variable representing the length of time for a base fee among the working time of the driver responsible for each job. A second variable is an overtime variable corresponding to overtime pay. A third variable is a night-time variable corresponding to the night-time allowance. A fourth variable is a vehicle time use variable corresponding to the vehicle cost. The vehicle cost is a term proportional to a use time. In addition, by using flag values, the delivery plan creation unit 30 can also support payment rules that include case classification such that “for short-time use, the payment is proportional to the use time of vehicle and driver, and for long-time use, the payment is fixed considered as a one-day charter”. Then, by using accurate fees as an element of the objective function, the delivery plan creation unit 30 can create a delivery plan more conforming to actual conditions.

### 8. Cargo Handling Separation Connection Constraint

The delivery plan creation unit 30 takes into account the allocation of vehicles to cargo handling berth facilities at respective bases and time frames by using an interval variable which is an extension of the CP-SAT solver. This avoids the risk of making the plan infeasible due to allocating too many vehicles to a base with insufficient facilities. In addition, the use of the extension in the CP-SAT solver enables more lightweight implementation.

### 9. Cross-Multiply Constraint

The delivery plan creation unit 30 newly establishes a cross-multiply edge variable (binary) linked to the vehicle use time variable on condition that the same schedule is used repeatedly in units of X days. Because of this, the delivery plan creation unit 30 can have a solvable range that covers a repeatable schedule including rotation of vehicles in use without excess nor shortage.

In addition, by combining the function [10. Multiple affiliated base] with the function [9. Cross-Multiply Constraint], the delivery plan creation unit 30 can limit connection targets of cross-multiply edges to the jobs handled by drivers belonging to the same single base. Because of this, the delivery plan creation unit 30 improves flexibility in plan creation and develops more efficient and accurate delivery plans, as compared with methods of limiting the working time of the vehicle itself (e.g., 24 hours for a daily unit).

### 10. Multiple Affiliated Bases

The delivery plan creation unit 30 defines a location relationship of multiple departure location candidates for vehicle departing. The delivery plan creation unit 30 creates the delivery plan with an additional constraint that links the vehicle departure location to the vehicle arrival location from among a number of departure location candidates. Specifically, the delivery plan creation unit 30 defines a location relationship between one or more departure location candidates and each job and adds such a constraint that the departure base and the arrival base be the same for each vehicle and driver. In other words, the formulation enables designation of multiple depots. This improves plan flexibility and enables more efficient delivery plan creation, as compared with a process that uses only a single departure base.

In detail, a single affiliated base has a limit on the number of drivers in addition to the number of vehicles belonging this base. An example of the restriction is such that persons belonging to a certain sales office and able to drive an 11-t truck are three in total. Therefore, in the delivery plan creation unit 30, a limit on the number of vehicles for each vehicle class and information indicating the number of drivers corresponding to the vehicle class can be set individually for each base as the constraint for each base. Because of this, for each affiliated base, it is possible to finely designate how many vehicles of which vehicle class can depart. The delivery plan creation unit 30 can create the delivery plan taking into account how many vehicles of which class can depart at respective bases.

As a result, when the location relationship is geographically distant in particular, it is expected that the system is effective in simultaneous handling of multiple jobs preferably divided among multiple vehicles departing from different sales offices. In addition, the labor responsibility can be reduced by fixing at “departure location=arrival location”. Furthermore, because it is possible to take into account the number of vehicles per vehicle class arrangeable for each depot (sales office), it is possible to pose a limitation on the number and type of drivers (working style preferences, etc.). Additionally, if the container is taken into account, it is possible to pose the limitation on the number of containers for ease base. As a result, delivery plan creation accuracy is improved, and more efficient operation is achieved.

### 11. Vehicle Class Classification

The delivery plan creation unit 30 newly establishes a variable representing the vehicle class of the vehicle responsible for each job (hereinafter referred to as the vehicle class variable). By using the vehicle class variable, the delivery plan creation unit 30 provides a system able to take into account difference in capacity and fee based on vehicle type and can handle the capacity and fee differently depending on which type of vehicle is used.

In addition to the vehicle capacity and fee, the delivery plan creation unit 30 can take into account a change in operation pattern made available by cooperating the function [12. Vehicle Lumber Limitation for Each Base] and the function [13. Container Handover]. The delivery plan creation unit 30 takes into account tradeoff including the change in operation pattern and creates an optimal delivery plan, thereby improving plan creation flexibility and efficiency. This improves versatility and accuracy and enables creation of delivery plans adaptable to a variety of operating conditions.

### 12. Vehicle Number Limitation for Each Base

The delivery plan creation unit 30 newly has a variable that represents the number of vehicles having departed from each base. The delivery plan creation unit 30 uses this variable to provide a system able to take into account the number of vehicles available at each base. By taking into account the different number of available vehicles at respective bases, the delivery plan creation unit 30 can create the delivery plan more conforming to actual conditions.

Specifically, the delivery plan creation unit 30 has the additional variable for managing the number of vehicles having departed from each base and makes the plans based on the number of vehicles available at each location. In this way, the delivery plan creation unit 30 creates a plan by reflecting the constraint on the number of vehicles at each base to conform to real operational conditions. The delivery plan creation unit 30 is versatile to support a variety of bases, improving plan creation accuracy and efficiency.

### 13. Container Handover

When the swap-body container vehicle, which is able to separate the container from the vehicle body, is used as the transporter, the delivery plan creation unit 30 sets a parameter (variables) specific to the swap-body container vehicle (hereafter referred to as SLOC vehicle). SLOC is abbreviation for Shuttle Line Of Communication. The delivery plan creation unit 30 defines four variables to support container transfer in the SLOC vehicles.

A first variable is a variable indicating whether the vehicle is a SLOC vehicle or not (binary N). A second variable is a variable indicating whether or not the container has been connected (binary N*N). A third variable is a variable indicating whether or not a cargo handling exemption has happened (binary 2*N). A fourth variable is a variable indicating the cargo handling time itself (2*N). With the definition of these four variables and the MTZ formulation described above, the reduction in cargo handling time due to container use can be defined.

When the SLOC vehicles are used as the transporters, the delivery plan creation unit 30 creates the delivery plan so that the indicator KPI and the fee, etc., as described in [7. KPI Totaling (1)], can be optimized (minimized) via reducing the cargo handling time by container replacement. As a result, it is possible to create efficient relay plans for long-distance tasks using SLOC vehicles. The delivery plan creation unit 30 may have addition of a loading flag variable that indicates the loading contents at a single job.

Specifically, the delivery plan creation unit 30 establishes such a constraint that “for two consecutive sections among multiple section jobs derived from a single long-distance task, a vehicle A is responsible for the earlier section job and a vehicle B is responsible for the later section job. If the container transfer flag from vehicle A to vehicle B is ON, then the vehicle A is exempted from unloading and the vehicle B is exempted from loading.”

If the function [11. Vehicle Class Classification] is implemented in the delivery plan creation unit 30, the delivery plan creation unit 30 can take into account the tradeoff between vehicle cost and container movement flexibility by distinguishing between SLOC vehicles and non-SLOC vehicles. Because of this, for split delivery on a long-distance task, it is possible to replace transfer of packages between trucks with an operation of transfer of the container to a truck, significantly reducing cargo handling time and increasing efficiency.

The delivery plan creation unit 30 sets parameters unique to the SLOC vehicles by providing parameters such as the number of SLOC vehicles, SLOC vehicle cost, and the time required for container cargo handling as inputs. Because of this, the delivery plan creation unit 30 enables implementation taking into account the following three points. A first point concerns how cargo handling time is reduced taking into account the duplication at package receipt and handover. A second point concerns exact adjustment of timing where receipt and handover are possible. A third consideration concerns container balance before and after the implementation of the schedule. By using the MTZ formulation, the delivery plan creation unit 30 can achieve optimization that takes into account the parameters unique to SLOC vehicles with a small amount of computation or man-hours.

### 14. Stopover Definition

The delivery plan creation unit 30 newly sets a stopover variable representing an act of returning to the affiliated base and performing the settlement cargo handling in the middle of the operation. The settlement cargo handling refers to, in a pickup task, an unloading cargo handling of, after traveling for package pickup, collectively unloading the packages upon return to the depot. The settlement cargo handling refers to, in a delivery task, a loading cargo handling of, before traveling for package delivery, collectively loading packages at the depot before departure. The stopover variable indicates whether the stopover has been made after a job.

When the stopover variable is ON, the delivery plan creation unit 30 establishes an exception handling at the connection, so that the settlement cargo handling in the middle of the operation is performable. The settlement cargo handling refers to loading and unloading packages collectively at times of departure and arrival. Since the accumulated capacity is reset due the settlement cargo handling, the number of jobs handleable by a single driver increases in relation to the capacity constraint. Thus, the delivery plan creation unit 30 can increase the flexibility in delivery plan creation by introducing the stopover variable.

In addition, by combining the below described function [16. Multiple Relay Points] with the function [14. Stopover Definition], the delivery plan creation unit 30 performs settlement at a time when the vehicle arrives at a location close to the corresponding relay point of the delivery job, if respective job bases are far from each other. This improves the flexibility and efficiency of the delivery plan, enabling the delivery plan creation unit 30 to create a more realistic delivery plan.

### 15. Section Job

For compensating for elimination of such concept of the settlement cargo handling as “loading for delivery task and unloading for package pickup task,” the delivery plan creation unit 30 defines one set of “loading at a loading location, traveling, and unloading at an unloading location” as a single job. Specifically, the concept of settlement cargo handling, such as “collectively loading at departure” and “collectively unloading at arrival,” is eliminated, and each job is defined in units of “loading at the loading location, traveling, and unloading at the unloading location.” This enables the delivery plan creation unit 30 to create flexible delivery plans that support such complex distribution of bases that loading locations and unloading locations are so diverse that handling by both the pickup task and the delivery task is impossible.

In addition, the delivery plan creation unit 30 combines the functions [14. Stopover Definition] with [15. Section Job] to change the interpretation of the stopover variable and the settlement, so that travel for pickup and travel for delivery can be expressed using almost the same formulation. Because of this, it is possible to handle problems having such base distribution that loading and unloading locations for each job are complex, increasing system versatility.

Furthermore, this [15. Section Job] is the premise for the formulation in the below described [18. Split Delivery]. Because of the definition of the section job, it is possible to handle complex base distribution and diverse loading and unloading locations and it is possible to create more realistic and efficient delivery plans.

### 16. Multiple Relay Points

The delivery plan creation unit 30 sets a relay point corresponding to each job as a new input constant, and also sets a cumulative exhaustive relay point at each job as a new variable. The input constant and the variable enable the delivery plan creation unit 30 to handle delivery problems where each job has one or more individual delivery destinations.

In addition, in the pre-process, the delivery plan creation unit 30 calculates a shortest-route order in which relay points are visited corresponding to an exhaustive relay point pattern. In cases where the number of relay points is significantly small (e.g., less than about four times the number of jobs), the delivery plan creation unit 30 can find a solution at the same level of calculation speed as the case of a single relay point. Therefore, it is possible to increase the number of relay points without disadvantage. Because of this, it possible to generally apply to all types of relay logistics plans with a small number of relay points and a large number of bases, e.g., each individual package having multiple separate destinations (relay points).

If the above-described [15. Section Job] function is implemented in the delivery plan creation unit 30, the concept of the delivery destination and the settlement cargo handling corresponding to the section job is absent, and these definitions are not necessary. Therefore, it is necessary to choose between the function [16. Multiple Relay Points] and the function [15. Section Job].

### 17. Connection Relationship Constraint

The delivery plan creation unit 30 applies the constraint “after completion of cargo handling of a certain job, start cargo handling of a corresponding job different from the certain job” for any of the following two purposes. A first purpose is to plan multi-stage delivery using multiple jobs for the same single package. This enables the delivery plan creation unit 30 to plan a complex delivery route where the package passes through multiple relay points to reach its final destination. A second purpose is to create a plan where an order in which the packages are retrieved and unloaded is fixed due to dwell space and loading manner issues at each base. This enables the delivery plan creation unit 30 to plan a delivery route that supports needs to retrieve and unload packages in a specific order.

When the function [15. Section Job] is combined with the function [17. Connection Relationship Constraint], the connection relationship constraint means that the cargo handling (unloading) done last in an earlier job is followed by the cargo handling (loading) done first in a later job. This enables the delivery plan creation unit 30 to support logistics plans in which the cargo handling order is designated and multi-stage delivery is included. Thus, the delivery plan creation unit 30 can efficiently develop logistics plans in which the cargo handling order is destinated and the complex multi-stage delivery is included, improving flexibility and accuracy in the delivery plan.

### 18. Split Delivery

With two procedures added, the delivery plan creation unit 30 creates a delivery plan that supports a long-distance task that cannot be carried without being divided (bucket relayed) between multiple drivers. In other words, the delivery plan creation unit 30 adds a cargo category “long-distance task” indicating a package that is not transportable in a single section.

Specifically, the delivery plan creation unit 30 performs a pre-process in which a single long-distance task for transporting a package is divided into small section jobs visiting multiple relay points. The delivery plan creation unit 30 newly provides the location (latitude and longitude) and distance information of the candidate relay points as input and performs the division into small section jobs. Next, the delivery plan creation unit 30 creates a delivery plan with an additional constraint that defines the connection relationship of the small sections jobs and capacity allocation for the small sections jobs into which a single long-distance task is divided. Because of this, the constrain on the connection relationship of all the section jobs originating from the same parent job and the constraint on sharing the capacity allocation and the route are newly imposed.

When the function [13. Container Handover] is implemented in the delivery plan creation unit 30, unloading and receiving in the connected jobs derived from the same single long-distance task are handled by the container transfer. Where the below described function [20. Route Selection] is implemented in the delivery plan creation unit 30, added is a pre-process of retrieving a plurality of candidate routes in an order from the shortest route and associating it with respective small section jobs when a long-distance task is divided into the multiple small section jobs.

The delivery plan creation unit 30 supports such long-distance trunk transport that a single driver cannot complete transportation of a single package. In particular, under an incentive labor standard requiring each driver to return to an operation starting point within a working time of 11 hours, long-distance delivery of 300 km or more should be divided between two or more persons. However, the split delivery may expand a range of handleable packages. Furthermore, the delivery plan creation unit 30 can efficiently develop complex long-distance delivery plans, improving delivery plan accuracy and flexibility.

### 19. Continuous Section Cargo Handling Exemption

When the section jobs that are connected via the stopover and correspond to the same single package are included, the delivery plan creation unit 30 sets an exception handling of exempting from unloading in an earlier job and from loading in a later job. The delivery plan creation unit 30 corrects the cargo handling time by removing such meaningless (unnecessary) cargo handling that the package is unloaded from a vehicle and loaded onto the vehicle. The delivery plan creation unit 30 eliminates an inefficient operation that may occur when multi-stage transportation is divided into multiple jobs. As a result, unnecessary work is eliminated, and more realistic and efficient delivery planning is possible.

### 20. Route Selection

The delivery plan creation unit 30 newly sets route selection flag variables which are the departure and arrival locations of the small section job and respective time windows reserved for the departure and arrival locations. The route selection flag variables are used to variablize the departure locations, the arrival locations, and the time windows of the small section jobs. The route selection flag variable enables the delivery plan creation unit 30 to flexibly change the departure location, the arrival location, and the respective time windows of each small section job. As described above, the delivery plan creation unit 30 can select the optimal route and the time in various cases, including a case of handling the small section jobs based on the multi-stage delivery such as [18. Split Delivery], and a case of handling packages with multiple candidate destinations in the form of small section jobs. As a result, delivery planning flexibility improves.

### 21. Restriction on the Number of Assignments

The delivery plan creation unit 30 sets a cumulative assigned-work count variable. By the cumulative assigned-work count variable, the delivery plan creation unit 30 sets upper limits of the number of bases, the number of jobs, and the number of companies that each driver and vehicle is responsible for, so that tradeoff between operation difficulty and efficiency can be taken into account.

In detail, the delivery plan creation unit 30 sets the restriction on the number and type of works per driver to reduce learning burden. In addition, the delivery plan creation unit 30 imposes the restriction on works that each vehicle is responsible for. Because of this, the learning burden can be reduced even in such workplaces that “the same schedule is continuously run for multiple days in which the works (early and late shifts, etc.) for multiple drivers belonging to the same single vehicle are handled by multiple people by rotation.”

According to the above, the delivery plan for each driver and vehicle are optimized, enabling efficient operation management. In addition, the delivery plan creation unit 30 can provide flexible plans conforming to actual operations while balancing operational difficulty and efficiency.

### 22. KPI Totaling (2)

The delivery plan creation unit 30 sets a cumulative distance variable and a toll road payment variable. The delivery plan creation unit 30 totals delivery distances by using the cumulative distance variable. The delivery plan creation unit 30 ascertains toll road use by using the toll road payment variable. The delivery plan creation unit 30 can provide KPI taking into account additional fees, labor responsibility, environmental responsibility, and other factors that happen when using respective routes, and therefore create delivery plans more conforming to actual conditions.

### 23. Package Type Consideration

For the package of a special class such as hazardous material and refrigeration required, the delivery plan creation unit 30 can impose restrictions on traveling time, speed, and route. Assuming the implementation of the function [11. Vehicle Class Classification], the delivery plan creation unit 30 can add restrictions on transportation vehicle with respect to the packages that the vehicles of only specified types are permitted to handle, such as packages of refrigeration required and chemicals. This results in an increase in types of packages supported in the logistics planning system 100 and versatility improvement, as compared with cases where restrictions on route, transport time period, and vehicle type are not taken into account.

### 24. Robustness Restriction and Maximization

To deal with uncertainties in quantity and capacity of packages, the delivery plan creation unit 30 creates redundant and probabilistically stable delivery plans by linear relaxation of probability distribution of the capacity of each task and incorporation into the constraint and the objective function. This enables the delivery plan creation unit 30 to take measures against risk of increase or decrease in package quantity during the execution of the plan if part of the data has an error or numerical discrepancy.

In addition, when delivery plans for individual consumers are created, there may be significant unpredictable uncertainties, such as changes in plans on the day of delivery. The delivery plan creation unit 30 can avoid risk of big change in plan by creating delivery plans ensuring robustness.

Furthermore, when a plan is created by companies jointly, logistics of the company that do not have accurate data may cause significant uncertainties. For example, if items for dimension and weight are absent in a customer form and measuring equipment is absent in a warehouse, a person in charge may think of a loading plan by his or her intuition after packages arrive. This may deteriorate loading efficiency. However, according to the creation method of delivery plans with robustness taking into account the uncertainties, it is possible to reduce the risk even in the absence of data on accurate capacity and dimensions.

### 25. Buffer Package Consideration

The delivery plan creation unit 30 defines a regular package and a buffer package. The regular package is a package that is required to be delivered in a single delivery plan. The buffer package is a package that is not necessarily required to be delivered in a single delivery plan. The delivery plan creation unit 30 adds case classification on whether the buffer package is included or not included in the delivery plan, thereby improving efficiency of the delivery.

The delivery plan creation unit 30 performs the following two types, depending on the package capacity. Specifically, if the total cargo quantity for a certain departure/arrival location and a time frame is small and there is the regular package for the same departure/arrival location and time frame, the delivery plan creation unit 30 variablizes the total capacity of the task including the regular package and the buffer package on assumption that the buffer package is to be delivered together.

If there is no regular package, the delivery plan creation unit 30 adds, at the pre-process, a task (also referred to hereinafter as buffer task) with a variable total capacity having the buffer packages only. The delivery plan creation unit 30 treats the buffer task as a task that may or may not be included in the delivery plan. In any case, the delivery plan creation unit 30 treats the capacity of the buffer part as being variable from 0 to the total capacity, so that the total capacity of the transported buffer package is included in the objective function.

As described above, the delivery plan creation unit 30 adds the buffer package to the delivery plan only when it achieves cost saving. This enables efficient schedule creation as compared with cases of manually deciding, at creation of the input data, whether to add the buffer package to the delivery plan.

### 26. Deadline Constraint

The delivery plan creation unit 30 sets a constraint (hereinafter referred to as “deadline constraint”) that establishes time frame designation for the settlement cargo handling, such as loading and unloading at the base, unloading in the package pickup, and loading in the package delivery. For example, if a time period when the package is at the relay point is short (e.g., less than half a day), it is necessary to pick up the package immediately after it is placed at the relay point in view of a delivery deadline and a residence time at the relay point. By setting a deadline constraint, the delivery plan creation unit 30 can develop an accurate relay plan.

When the function [15. Section Job] is implemented in the delivery plan creation unit 30, the settlement cargo handling is included in the job, so that the time window for the settlement is able to be designated without separate implementation of the deadline constraint. Therefore, it is necessary to choose between the function [15. Section Job] and the function [26. Deadline Constraint].

### 27. Minimization of Change from Current Schedule

The delivery plan creation unit 30 reduces the learning burden for drivers and base operators by reading each task definition and connection information between tasks in the current schedule as the input information. In this way, the delivery plan creation unit 30 develops an optimal new schedule that is close to the current schedule and has the minimized change in three points: the number of tasks; the correspondence between the tasks and the packages; and the loading and unloading orders for each task.

In order to minimize the change from the current schedule, the delivery plan creation unit 30 adds, at the pre-process, such constraint that, in the optimization process of determining the number of tasks and the time windows for each task, the allocation is performed so as to have the close correspondence with the tasks and the time windows of the current schedule. For each task, the delivery plan creation unit 30 also defines which task (0 to multiple) in the current schedule corresponds to the task.

Based on the correspondence relationship with each task in the current schedule, the delivery plan creation unit 30 adds a constraint or objective function for reducing the penalty according to connection between the tasks, specifically, the number of cases in which “loading for which task is to be performed after loading for which task is performed” is the same as in the current schedule. This reduces the learning burden on drivers and base operators in relation to frequent change in contents of assigned cargo handling and base and reduces the risk such as human errors.

In addition, risks due to implicit constraints not included in the input data are reduced. For example, if a cargo handling facility at a base is occupied all day long except a certain time frame (e.g., 14:00 to 15:00), a change in the cargo handling time from the current schedule may make the schedule unworkable. The delivery plan creation unit 30 can develop a schedule taking into account the constraint on not-digitalized actual onsite situations and can provide delivery plan conforming to actual circumstances.

### Use Cases and Common Flow in Delivery Plan Creation Unit

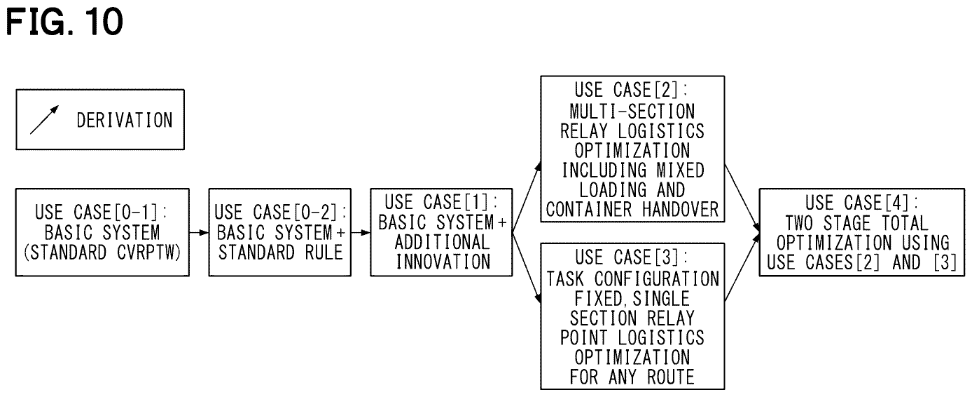

The functions implementable in the delivery plan creation unit 30 described so far include a function to be chose between two or more options and a function that is disadvantageous in calculation amount. Therefore, it is necessary to make a function selection adapted to use of the logistics planning system 100. As illustrated in FIG. 10, except for the basic system performing the MTZ formulation, multiple use cases with different advantages are derived depending on which constraint is added.

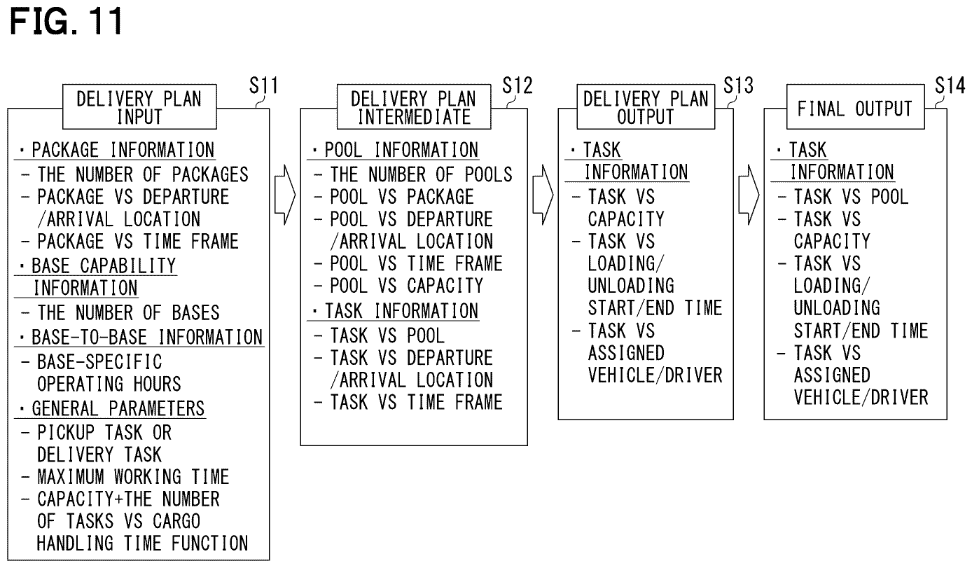

First, details of the flow common to respective use cases will be described using FIG. 11. First, in an input step (S11), the delivery plan creation unit 30 acquires the package information, the base capability information, the base-to-base information, and the general parameters as the input data. The package information includes the information on the number of packages, the information linking the package to the departure and arrival locations, and the information linking the package to the time window. The base capability information includes the information on the number of bases. The base-to-base information includes information indicating the time required to travel between locations. The general parameters include information that links the pickup task to the delivery task, the maximum working time, and the function representing a relationship of the capacity and the number of tasks with the cargo handling time.

In a next intermediate step (S12), the delivery plan creation unit 30 performs the pre-process of determining the intermediate constants. The delivery plan creation unit 30 creates the pool information and the task information. The pool information includes the information on the number of pools, the information linking the pool to the package, the information linking the pool to the departure and arrival locations, the information linking the pool to the time window, and the information linking the pool to the capacity. The task information includes the information linking the task to the pool, the information linking the task to the departure and arrival locations, and the information linking the task to the time window.

The delivery plan creation unit 30 defines the pool by grouping packages that have the same departure/arrival location and the close time window. The delivery plan creation unit 30 specifies a dominant loading limit factor (e.g., capacity, weight, dimensions, etc.) of the packages in the pool and calculates the pool capacity (e.g., corresponding to how many trucks, expressed in percentage %, etc.). The delivery plan creation unit 30 determines the minimum number of required trucks based on the pool capacity, i.e., determines the number of tasks. For example, when the pool capacity is 250%, the number of tasks is 3.

In an output step (S13), the delivery plan creation unit 30 creates the task information. The task information includes the information linking the task to the capacity, the information linking the task to the start and end clock times of loading and unloading, and the information linking the task to the assigned vehicle and the assigned driver. In the output step, the delivery plan creation unit 30 acquires the decision variable information found by the combinatorial optimization using the variable capacity CVRPTW.

The delivery plan creation unit 30 uses the task information created in the intermediate step and the output step as a final output. In the final output step (S14), the delivery plan creation unit 30 provides the final output to the loading plan creation unit 40. The task information provided as the final output includes the information linking the task to the pool, the information linking the task to the capacity, the information linking the task to the start and end clock times of loading and unloading, and the information linking the task to the assigned vehicle and the assigned driver.

### Details of the Delivery Plan Creation Unit of the Basic System

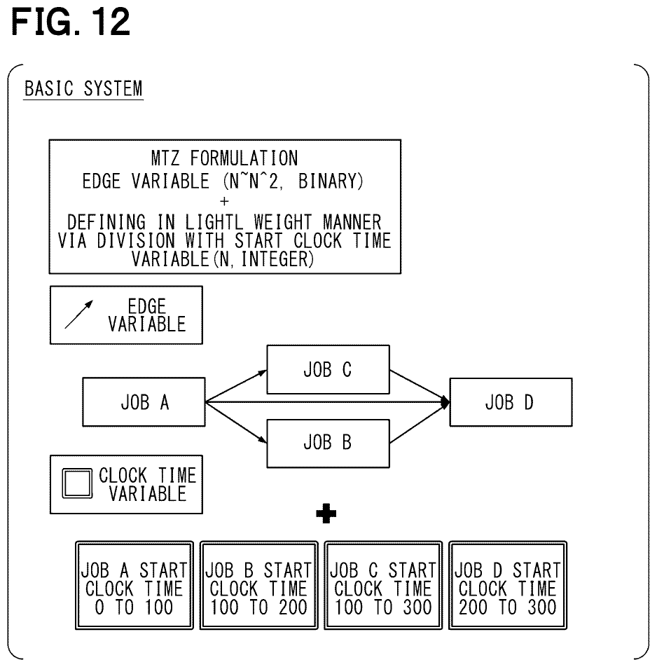

In the delivery plan creation unit 30 of the basic system illustrated in FIG. 12, the MTZ formulation using the CP-SAT type solver provides the lightweight definitions by dividing with the edge variable and the clock time variable. This makes it possible to perform the formulation in units of edge and improve efficiency, because the system enables such writing that “only when the edge of job A→B is ON, A start clock time+travel and cargo handling time<B start clock time.” The edge is the driver connection. In this case, the number of variables is significantly less than N\hat{ }2 because impossible connections (e.g., job D→A) are not definable.

In addition, it is possible to add the constraint by using a single binary variable proportional to the number of jobs to the power of 1 or 2, e.g., “if the break flag value is ON after job A, the required time from A to B is +30 minutes . . .” and “the cumulative break time is +30 minutes . . . ” In this way, it is possible to finely set conditions, and it is possible to construct a system that prevents a calculation amount increase.

The delivery plan creation unit 30 of the basic system in the use case [0-1] illustrated in FIG. 13 performs the three pre-processes that use the package information and prepares the pool, the capacity, and the task information. The pre-process for the package and the pool determines the pool such that the packages matching each other in the departure/arrival location and time frame are collectively determined as the pool. The pre-process for the pool and the capacity determines the capacity with reference to the dominant factor based on the weights, capacities, and dimensions of the packages in the pool. The pre-process for the pool and the task determines the tasks so as to minimize the number of tasks based on the pool capacity.

The delivery plan creation unit 30 further sets the following constraints. A first constraint is that the packages are to be loaded at respective delivery destinations and unloaded at the depot (departure location). The second constraint is that the optimization is to be performed using three inputs: each task and the pool information; a traveling time matrix between locations; and the maximum working time. These constraints require the solution in which a driver (vehicle) visits each location (pool) the specified number of times (tasks), performs the cargo handling for a designated capacity, and returns within the maximum working time. In the above, it is clear that a feasible solution exists, and an object is to minimize the number of vehicles or the total working time. The capacity variablizing is achieved via expressing the cargo handling time as a linear function linked to the capacity and by matching the total capacity of the jobs to the pool capacity. Furthermore, the linear function is able to be designated for each pool as desired and can be fixed such that e.g., “capacity [%]×2=cargo handling time [minutes].”

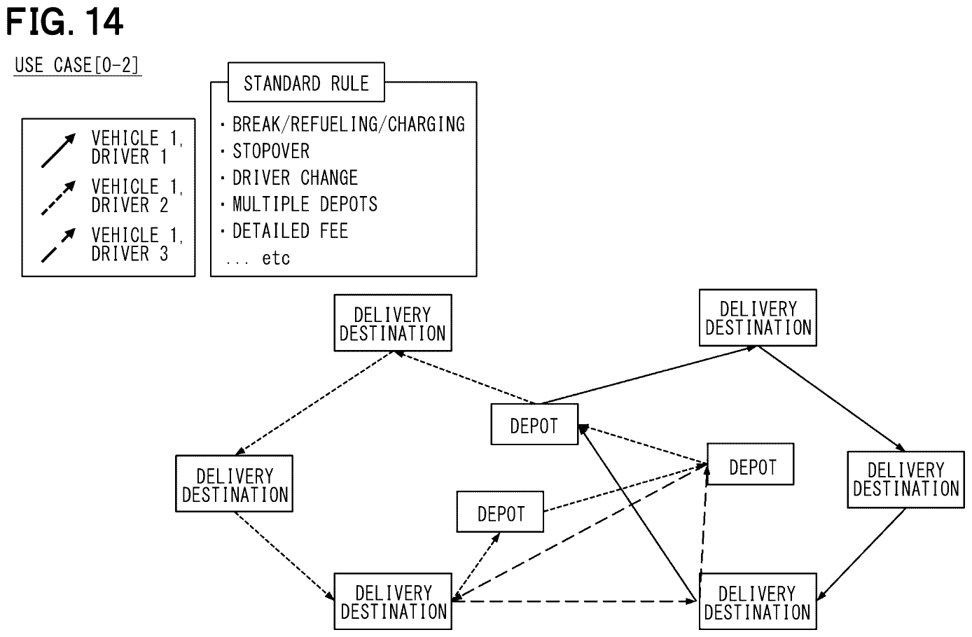

The delivery plan creation unit 30 of the basic system in the use case [0-2] illustrated in FIG. 14 has an added function of applying the standard rule. For example, the functions for breaking, refueling, charging, stopover, driver change, multiple depots, and fee totaling are implemented. In this use case, standard recommended references and general operating rules are added to improve flexibility and adequacy.

In detail, addition of the “driver change” function enables use of the same single vehicle by multiple persons, so that cases are classified for reducing the number of vehicles and vehicle cost. Addition of the “stopover” function enables such a process of returning to the depot in the middle of the operation and emptying the truck bed for a time. Furthermore, where the “breaking, refueling, charging” is added, if there is a certain amount of spare time in moving from job to job, the flag for breaking, refueling, etc., is ON and a rule for continuous traveling time or the like is set. When the “multiple depots” function is added, the case classification by the flag value is performed, so that the most efficient departure location is selectable.

Additional innovations are further implemented in the delivery plan creation unit 30 in the use case [1] derived from the use case [0-2], such as setting for the cross-multiply, the job number limitation, the multiple vehicle classes, etc. (see FIG. 10). This enables the delivery plan creation unit 30 in the use case [1] to adopt unique constraints. This results in improvement in system flexibility and adequacy and enables versatile uses.

### Details of Delivery Plan Creation unit of Developed System

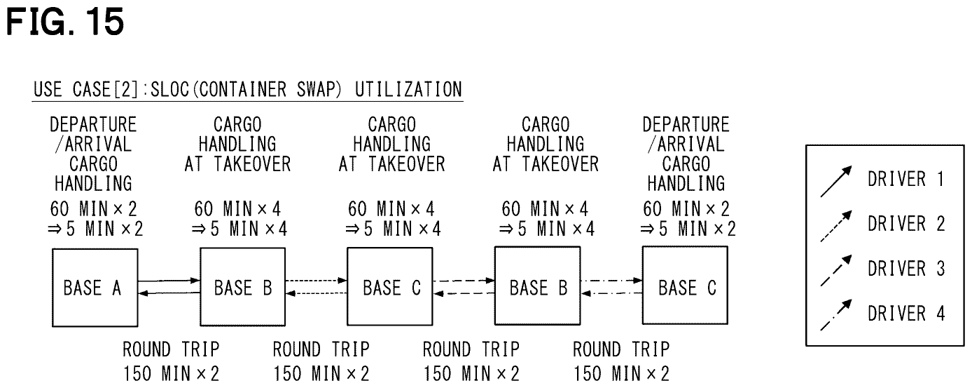

The delivery plan creation unit 30 in the use case [2] illustrated in FIGS. 15 to 18 is a form derived from the use case [1]. The delivery plan creation unit 30 in the use case [2] can take into account the container swap using the SLOC vehicle. Specifically, the delivery plan creation unit 30 plans the long-distance trunk transport, including dynamic transshipment and container delivery. The delivery plan creation unit 30 can find a solution with a calculation amount as a function of the capacity and the delivery distance, regardless of quality of such data as the number of routes and capacity allocation.

As illustrated in FIG. 15, with use of the container swap, the cargo handling at takeover is the handover of the container. Because of this, the time required for loading and unloading at each location is decreased, for example, from 60 minutes ×4 to 5 minutes×4. The cargo handling at departure and arrival at each base is borne by the base with the lower fee and labor responsibility. In the case of two-way round-trip logistics, if the one-way traveling time between bases is set at 150 minutes and the break time is set at 60 minutes, the driver working time is decreased from 600 minutes to 380 minutes.

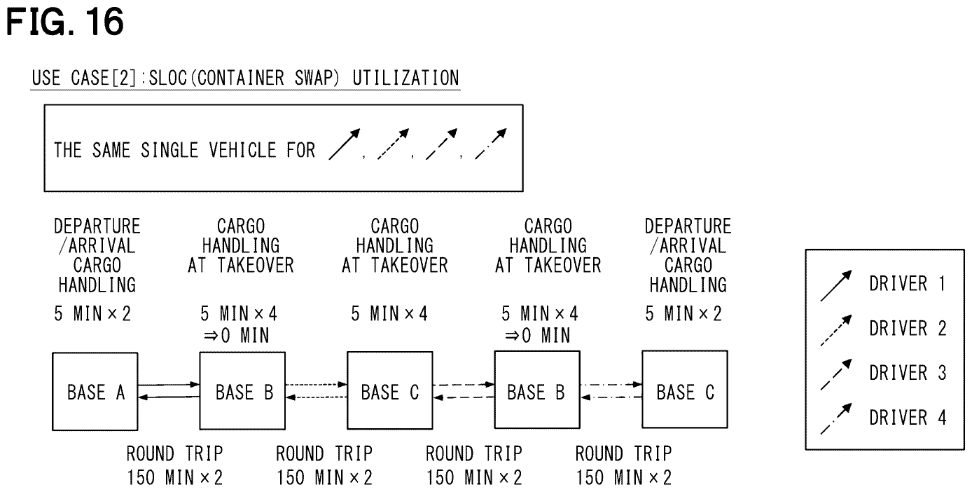

As illustrated in FIG. 16, when a single SLOC vehicle is used by changing drivers, the time required for loading and unloading at the time of takeover is virtually zero (see base B). Such decrease in cargo handling at the time of takeover further reduce the driver working time from 380 minutes to 370 minutes.

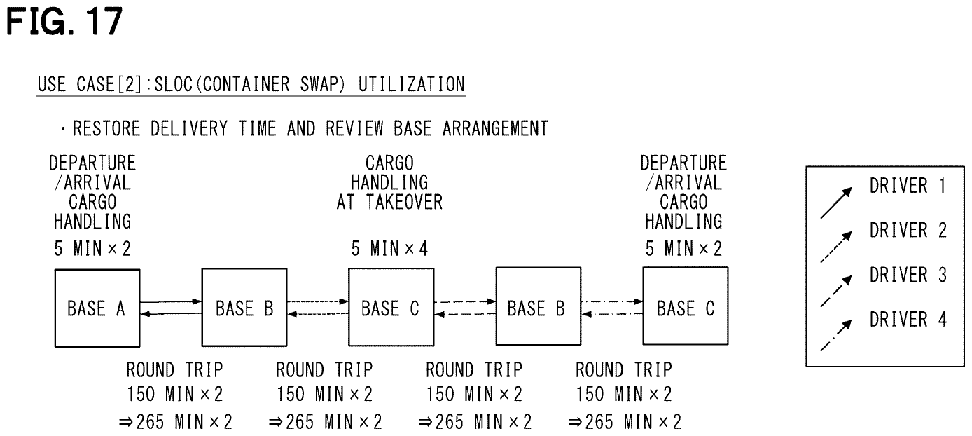

As illustrated in FIG. 17, it is possible to restore a delivery time and review base arrangement, assuming the SLOC vehicle transfer. The distance between bases (delivery distance) increases from 200 km to 380 km. Because of this, the one-way traveling time between bases is increased from 150 minutes to 265 minutes. As a result, transportation of 380 km is achieved by a working time of 600 minutes. According to the above, 1.8 times higher delivery efficiency is achieved as compared with the case of absence of SLOC vehicles.

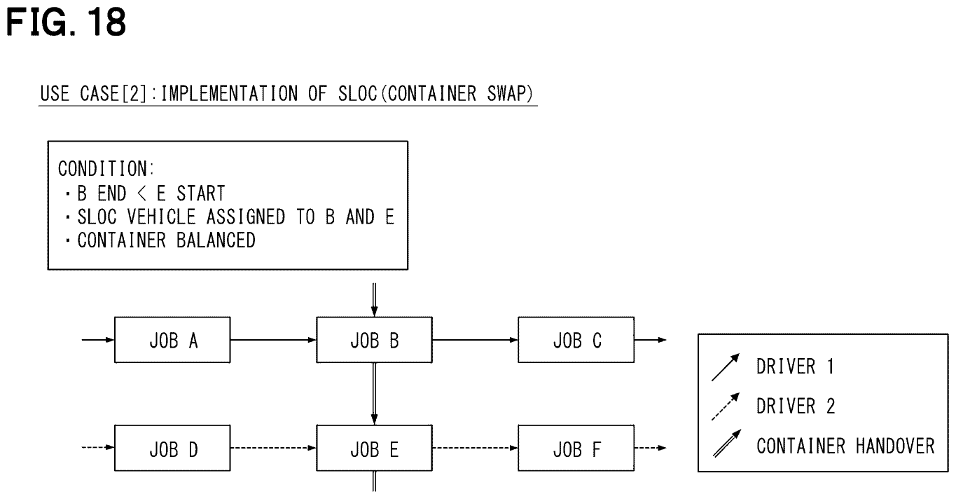

In FIG. 18, the container is handed over from driver A to driver B. By using the new type of solver, the delivery plan creation unit 30 can implement container handover by flag management. Specifically, the below three flags are used. A first flag is “if a vehicle responsible for both jobs A and B is the SLOC vehicle and the clock time to unload in the job A is earlier than the clock time to load in the job B, then the container delivery from the job A to the job B may be set to ON”. A second flag is “if the container delivery from job A to B is ON, the cargo handling for the common part of the cargo is exempted and 5 minutes is added to the time for the container transshipment”. A third flag is that the container is received immediately after it is handed over, except at the beginning and end of the work.

The delivery plan creation unit 30 sets the following three conditions. A first condition is “end of job B<start of job E”. A second condition is that “the vehicle in charge of jobs B and E is the SLOC vehicle.” A third condition is “to break even on container”. If these conditions are met, the delivery plan creation unit 30 applies such constraint that “ the cargo handling of handover from Job B to Job E is decreased from the original cargo handling time to a fixed time (e.g. 5 minutes)”.

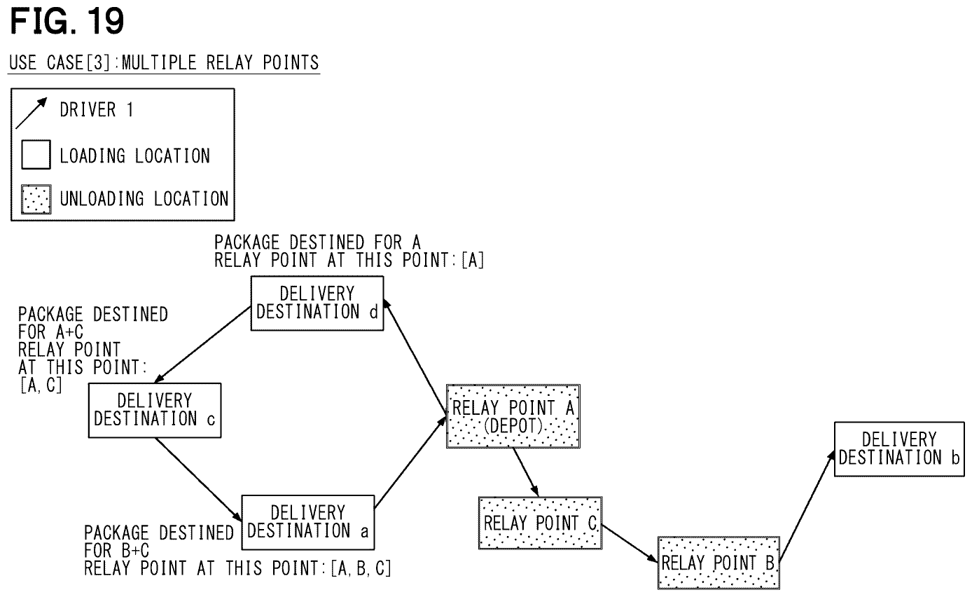

The delivery plan creation unit 30 in the use case [3] illustrated in FIG. 19 is another form derived from the use case [1]. The delivery plan creation unit 30 in the use case [3] can take into account multiple relay points. The delivery plan creation unit 30 implements the function for multiple relay points in a lightweight manner by calculating in advance a route branch in the pre-process. The delivery plan creation unit 30 optimizes one-section relay point logistics for a flexible route while keeping the task configuration fixed. In other words, by fixing the task configuration and the relay point for transportation, it is possible to find a solution for a single separated section before/after the relay point. With this pre-process, as long as the number of relay points are up to about 5 to 10, it is possible to find a solution with almost the same amount of calculation as the case of a single relay point. This enables high speed processing although flexibility is less than the use case [2].

In the use case [3], a single driver visits multiple delivery destinations and relay points and performs loading and unloading. After departing from the relay point A, the driver performs loading at multiple deliver destinations d, c, a, and returns to the relay point A. In this case, the relay point A is a stopover point. In this case, because the corresponding relay points are [A, B, C] and the route from departure to arrival is “a→b”, the delivery order and traveling time are uniquely determined to be, for example, [a, A, C, B, b].

As described so far, where there are multiple relay points, if the number of relay points is small or the number of relay point patterns corresponding to the tasks is small, a pattern is calculated to aim for efficiency. Example of the pattern calculated in advance include such a pattern as “when the relay points A, B, C are visited on the way from the delivery destination a to the delivery destination b, a→A→C→B→b is the fastest route and is to be always used.” If the entire corresponding relay points (exhaustive relay point) for the onboard package at the time after job i is known, the required time for “job i=>stopover=>next job” is determined. As a result, it is possible to achieve speedup without increasing a calculation amount.

In addition, by using the functions in the use cases [2] and [3] together, a two-stage overall optimization may be performed as shown in the use case [4] illustrated in FIG. 10. In this use case, the task configuration and corresponding relay points are first determined as in the use case [3]. Then, as in the use case [2], the separation before/after the relay point is made, and a solution is sought by incorporating strict labor restrictions.

### Details of Loading Plan Creation Unit

The loading plan creation unit 40 (loading plan optimization unit 40a) illustrated in FIG. 1 and FIGS. 20 to 22 performs the following three functionality. A first functionality of the loading plan creation unit 40 is to support loading one by one in any standard. A second functionality of the loading plan creation unit 40 is to support logistics with complex follow-up loading by taking into account a cargo handling order, so that the cargo handling time is able to be stricter. A third functionality of the loading plan creation unit 40 is to seek a better solution if there is room in the objective function setting. For example, the loading plan creation unit 40 seeks a solution that increase the capacity of the buffer package, improve stability and robustness, etc.

The loading plan creation unit 40 creates a three-dimensional loading plan based on the size information of each of the multiple packages. Based on the size information, the loading plan creation unit 40 enables flexible arrangement of multiple box-shaped packages of any size in a 3D container of any shape. Thus, three-dimensional arrangement of packages of any standard one by one is supposed in the loading plan. This loading supposed in the loading plan is not loading in units of pallet. As a result, a highly flexible and efficient three-dimensional cargo configuration (hereafter referred to as 3D cargo configuration) can be created. In addition, from the delivery plan handed over from the delivery plan creation unit 30, the loading plan creation unit 40 ascertains information on the cargo quantity allocation required for the task and determines the package loading for the task to meet this load weight allocation.

The loading plan creation unit 40 creates the loading plan by using a function that takes into account the circumstances specific to each base and each package, a loading manner, and an increase/decrease in cargo handling time via loading coordinates. The cargo handling time is calculated by “base (entry/exit)+A×the number of cases +B×weight or volume+correction value for each base and for each package. This cargo handling time varies from job to job according to the traveling for loading and unloading. At the time of the first version of the delivery plan by the delivery plan creation unit 30, the cargo handling time is taken into account in some detail. The loading plan creation unit 40 determines again the cargo handling time in a strict manner and corrects the parameters in a recursive manner, so that the cargo handling time well conforming to the actual conditions is calculated. For example, the above process can take into account the following: even for the cargo handling for the same packages, the cargo handling time differs from base to base depending on the availability of equipment such as forklifts and auxiliary personnel, and the availability of space for opening of containers of trucks.

The loading plan creation unit 40 includes functional units derived from the basic configuration and the delivery plan creation unit 30, as illustrated in FIG. 20. The loading plan creation unit 40 uses multiple functional units to improve accuracy, adequacy, and versatility. In the below, the multiple functional units implemented in the loading plan creation unit 40 will be described in detail in turn.

### 1. Cargo Handling Order Consideration

The loading plan creation unit 40 creates the cargo handling order for multiple packages loaded onto a single vehicle, based on the input and output constraints set for each of the multiple packages. The input constraint includes a designation condition of loading and unloading (large order and cargo quantity limit) for each truck. The output constraint includes constraints on a cargo configuration and an unloading order, and various parameters. The loading plan creation unit 40 variablizes the loading order of packages and the unloading order of packages in loading and unloading for each task and takes into account whether an established cargo handling order corresponding to the cargo configuration is present.

The loading plan creation unit 40 uses the following procedure to seek a solution for an established combination of the cargo configuration, the arrangement coordinates, and the loading order. The loading plan creation unit 40 first classifies the case by using a flag variable (front, rear, left, right) for the package i as to in which direction the package is to be taken out. Next, the loading plan creation unit 40 imposes the following three constraints on the package i. A first constraint is that, at a time of cargo handling for the package i, there are no other packages getting in the way, specifically, there are no other package in the direction of retrieval, in close proximity, at a higher position, etc. A second constraint is that cargo configurations before and after the cargo handling for the package i meet a basic stability rule. A third constraint is that, at a time of cargo handling for the package i, a scaffold is available (e.g., a package-absent area or outside the vehicle) close enough in the retrieval direction from the coordinates of the package i.

With the above, the loading plan creation unit 40 outputs only the cargo configuration attained by a safe and feasible cargo handling order. As a result, it is possible to create the loading plan conforming to actual conditions. Furthermore, if the function [15. Multiple Relay Points] or the function [16. section job] is implemented in the delivery plan creation unit 30 (see FIG. 9) and the loading and unloading orders are in part designated in detail, the loading plan creation unit 40 cannot establish the loading plan without taking into account the cargo handling order.

### 2. Limiting and minimizing cargo handling time

The loading plan creation unit 40 establishes a cargo handling time variable linked to the cargo configuration and the loading manner by using a required time function corresponding to the vehicle class and the loading manner. In the required time function, the required time is calculated as the sum of the base time corresponding to the vehicle class and the loading time f(i) for all packages i. The loading time f(i) is a linear function corresponding to the cargo type, weight, volume, loading coordinates, and loading manner type. The loading plan creation unit 40 incorporates the loading time variable into the objective function. In addition, the loading plan creation unit 40 designates the upper limit by means of the constraint, if necessary. The above enables the loading plan creation unit 40 to minimize and limit the cargo handling time. The loading plan creation unit 40 can output only the cargo configuration enabling the work to complete within a given time and the delivery plan to be feasible, so that the loading plan conforming to actual conditions can be created. By selecting a solution that reduces the cargo handling time within the range of constraints, the loading plan creation unit 40 can output the plan with low labor responsibility.

### 3. Stability Maximization

The loading plan creation unit 40 calculates a score value that indicates the stability of packages loaded on the vehicle (truck) or the stability of entire vehicle. The loading plan creation unit 40 can separately define the stability of packages and the stability of entire vehicle in a state where the packages have been loaded. The loading plan creation unit 40 incorporates the score value for the stability into the objective function of the loading plan so that stability is maximized. The score value quantifies how far the center of gravity of the packages is from the center of gravity of the vehicle, how much the vehicle is tilted due to the center of gravity of the entire packages, and so on. When the function [3. Maximize stability] is implemented together with the function [1. Cargo Handling Order Consideration] above, the stability for each frame can be taken into account, the cargo handling can be performed safely.

Specifically, the stability score value g(i) for the package i is expressed as a linear function independent of other packages, as follows:
g(i)=Ai×a ratio of installation area+Bi×the number of steps+Ci×displacement of X-coordinate from the center of gravity+Di×displacement of Y-coordinate from the center of gravity+Ei×displacement of Z-coordinate from the center of gravity.

Ai to Ei above are constants corresponding to i. Ai is negative. Bi to Ei are positive. The smaller g(i) indicates more stable.

The loading plan creation unit 40 takes into account the trade-off between safety and efficiency to output the cargo configuration that not only meets minimum rules but also is as stable as possible, whereby the loading plan conforming to the actual situation is created. Criteria for the stability include fewer gaps, arranging a heavy package at a lower part, and the center of gravity closer to the center of the truck.

### 4. Limitation and Maximization of Robustness

When there is an uncertainty about the dimensions of the package or other factors, the loading plan creation unit 40 creates a redundant and probabilistically stable plan by linearly relaxation of the probability distribution and incorporation into the constraints and objective function. When the above functions 1 to 3 are implemented, the loading plan creation unit 40 can take into account uncertainties in loading feasibility, cargo handling time, and cargo stability. The loading plan creation unit 40 can take measures against a risk of cargo quantity increase or decrease during the execution of the plan, even if some of the data contains errors or numerical discrepancies. Thus, as a derivation of [24. Limitation and Maximization of Robustness] in the delivery plan creation unit 30, the uncertainty is also taken into account in the loading plan, so as to avoid such risk that the solution is inefficient or infeasible.

### 5. Buffer Package Consideration

The loading plan creation unit 40 takes into account the buffer package separately from the regular package. The loading plan creation unit 40 creates a more efficient plan by setting how much additional buffer package is loaded into the objective function. The loading plan creation unit 40 calculates an efficient schedule by including the buffer package in the loading plan only if cost reduction is achieved. In addition, as a derivation of [25. Buffer Package Consideration] in the delivery plan creation unit 30, the buffer package is also taken into account in the loading plan, so as to avoid such risk that the solution is inefficient or infeasible.

### 6. Minimization of Change from Current Cargo Configuration

By newly reading the task configuration, the cargo configuration, and the cargo handling order of each task in the current schedule as the input information, the loading plan creation unit 40 can develop the loading plan that is close to the current plan and that has minimal changes in cargo configuration and cargo handling order. This function is a function derived from [27. Minimization of Change from Current Schedule] in the delivery plan creation unit 30. This reduces the learning burden and learning cost for drivers and base operators, reduces the risk of human error, and also reduces the risk due to implicit constraints not included in the input data.

### 7. Long-Distance Task Split Delivery

The loading plan creation unit 40 adds an exception handling that splits a single task into multiple jobs, for a long-distance task to be divided between two or more persons. This function is derived from [18. Split Delivery] in the delivery plan creation unit 30. The loading plan creation unit 40 calculates the package arrangement after the cargo handling in units of job and adds such constraint that package allocation is the same among multiple jobs derived from the same single task. Because of this, it is possible to support the long-distance task that is not completable by a single driver alone.

### 8. Vehicle Class Consideration

The loading plan creation unit 40 creates a loading plan based on the dimensions of the truck bed and the maximum loading weight according to the vehicle (truck) class, as well as rules related to stability. This function is a function derived from [11. Vehicle Class Classification] in the delivery plan creation unit 30. In the same way as the function [3. Charging and Refueling (2)] and the function [10. Multiple bases] in the delivery plan creation unit 30, and the function of correcting the cargo handling time taking into account individual circumstances in the loading plan creation unit 40, the function [8. Vehicle Class Consideration] also takes into account the case classification by vehicle class in the delivery plan. With the function of taking into account the vehicle class, the loading plan creation unit 40 is able to take into account tradeoffs concerning the capacity, the fee, and the change in feasible operating pattern due to the change in vehicle class. As a result, it is possible to improve flexibility in delivery planning.

### 9. Package-specific Loading Rule

The loading plan creation unit 40 adds a new input item for each package. The new input item is a case classification related to loading manner rules. Specifically, the loading plan creation unit 40 enables the rules (i.e., rules specific to packages) to be applied. Examples of the rule include: “placing a package below a certain package is prohibited”, “placing a package above a certain package is prohibited”, “a certain package is required to be placed along a wall,” and “a certain package is required to be fixed in a specific orientation.”

The above expands a range of packages handleable in the logistics planning. As a result, risks are reduced concerning packages for which the rules are not mandatory. In addition, plans well conforming to actual conditions are created. On the delivery planning system side, it is necessary to change only the pre-process for calculating the linking between the cargo and the pool and calculating the pool capacity. No major changes are required. Specifically, a method of calculating the pool capacity from the package is corrected according to the loading manner rule.

### 10. Pallets and Dummy Boxes

By the following two pre-processes and one constraint modification, the loading plan creation unit 40 can take into account an increase in stability using palletization and dummy boxes. As a first pre-process, the loading plan creation unit 40 collects small packages into a pallet in advance. As a second pre-process, the loading plan creation unit 40 registers in advance a dummy box as a buffer package that may or may not be used, according to a size difference of packages in the same single pool.

If, as a constraint, a completely closed space is created by addition of a certain package together with a wall or other packages, the loading plan creation unit 40 treats the space as being an originally added dummy box and the stability constraint as being satisfied. When the above-described functions 1 and 2 are implemented, the loading plan creation unit 40 further implements a function of calculating the loading order, the cargo handling feasibility, and the cargo handling time for the dummy boxes, in conjunction with the constraint rules.

According to the above, even in cases where the packages are not uniform in dimensions, or when the container and the packages do not match in dimensions, etc., the loading plan creation unit 40 can enjoy the benefits of ensuring the stability and increasing feasible solutions in exchange for deterioration of the loading capacity due to the use of the dummy box or pallet.

### Details of Loading Plan Creation Unit of Basic System

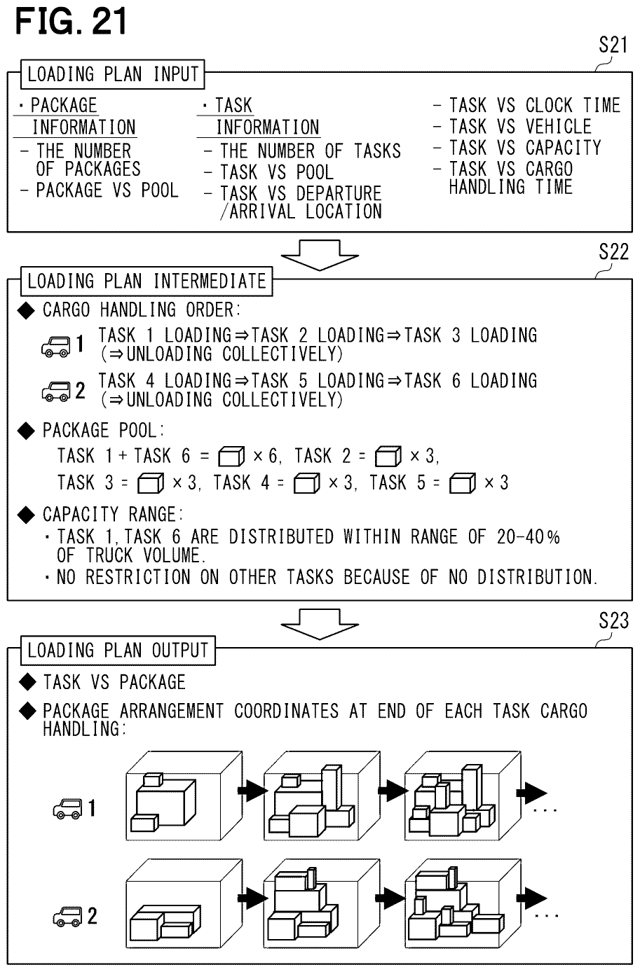

The loading plan creation unit 40 of the basic system illustrated in FIG. 21 enables loading an any sized package (carton) and outputs a 3D cargo configuration. The loading plan creation unit 40 receives information on the task and the cargo quantity allocation from the delivery plan creation unit 30 and determines how to load the packages of the task to satisfy the information. In the loading plan creation unit 40 of the basic system, only the information on the task and cargo quantity allocation is set as the constraints for the loading plan. In the basic system, no objective functions are set.

The loading plan creation unit 40 of the basic system has the following three functions. A first function of the loading plan creation unit 40 is to enable partial follow-up loading and unloading to be taken into account. A second function of the loading plan creation unit 40 is to enable the package allocation between multiple tasks. A third function of the loading plan creation unit 40 is to enable the packages of different volumes, dimensions, and weights to be taken into account.

If the cargo configuration requires a cargo handling operation of a high operation level or a high risk, the loading plan creation unit 40 may determine whether or not the cargo configuration is in an acceptable range. In the basic system, if the packages are collectively unloaded from the vehicle, it is easy to establish the loading plan. In other words, the loading plan creation unit 40 of the basic system may not support such delivery plans that only part of the packages is loaded or unloaded at multiple bases.

In the input step (S21) of the flow to calculate the loading plan, the loading plan creation unit 40 first acquires the package information and the task information as the input data. The package information is transmitted from the input processing unit 20 to the loading plan creation unit 40. The package information includes the information on the number of packages and the information on linking between the package and the pool. The task information is transmitted from the delivery plan creation unit 30 to the loading plan creation unit 40. The task information includes the information on the number of tasks, the information linking the task to the pool, the information linking the task to the start and end times of loading and unloading, the information linking the task to the clock time, the information linking the task to the vehicle, the information linking the task to the capacity, and the information linking the task to the cargo handling time.

In the next intermediate step (S22), the loading plan creation unit 40 calculates the cargo handling order, the package pool, and the capacity range. For example, the cargo handling order for the vehicle [1] is set to loading for tasks 1 to 3 and then collectively unloading. Similarly, the cargo handling order for the vehicle [2] is set to loading for tasks 4 to 6 and then collectively unloading. In addition, as the package pool, six packages are allocated to each of the tasks 1 and 6 and three packages are allocated to each of the tasks 2 to 5. Then, a restriction (capacity range) requiring the allocation in the range of 20 to 40% of the truck capacity is set to the tasks 1 and 6, and no restrictions are set to the other tasks.

In the output step (S23), the loading plan creation unit 40 creates the information linking the task to the package and each package arrangement coordinates at the end of each task cargo handling. Specifically, for the vehicle [1], the package arrangement is calculated assuming loading in the tasks 1 to 3. Similarly, for the vehicle, the package arrangement is calculated assuming loading in the tasks 4 to 6.

### Details of Loading Plan Creation Unit of Developed System

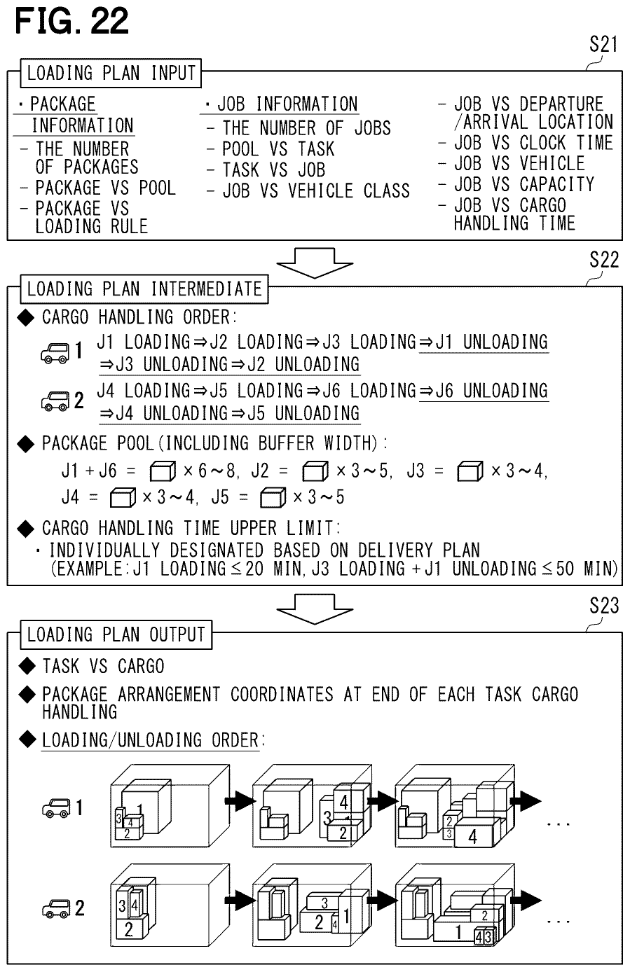

In addition to the correspondence between the task and the cargo quantity allocation, the robustness and the cargo handling time are set as constraints in the loading plan creation unit 40 of the developed system illustrated in FIG. 22. Constraints that may be further set include the cargo handling order, the loading manner rule, the vehicle class, etc. The increase in the loaded quantity of the buffer packages, the increase in the stability, and the reduction in the cargo handling time are set into the objective functions in the loading plan creation unit 40 of the developed system. The improvement in the robustness, the reduction in the change, and the like may be further set into the objective functions.

The loading plan creation unit 40 of the developed system improves versatility, adequacy, and accuracy. The versatility is improved by supporting the delivery plans including partial loading and unloading via the cargo handling order constraint. The versatility is also improved by increasing supported logistics via the loading rule for each package and the classification of vehicle classes. The adequacy is improved by reducing the risk of plan establishment failure via directly calculating and limiting the cargo handling time without capacity-constraint-based alternative approximation. In addition, the adequacy is also improved by reducing the risk of uncertainty-caused establishment failure via maximizing the robustness and minimizing the changes from the current cargo handling. The accuracy is improved by efficiency improvement via adding the buffer package if there is a room in the truck bed and via minimizing the cargo handling time.

In the input step (S21) of the flow for calculating the loading plan, the loading plan creation unit 40 first acquires the package information and the job information as the input data. The package information includes the information linking the package to the loading manner rule in addition to the information on the number of packages and the information linking the package to the pool. The job information corresponds to basic system task information. The job information includes the information on the number of jobs, the information linking the pool to the task, the information linking the task to the job, the information linking the job to the vehicle class, and the information linking the job to the departure and arrival locations. In addition, the job information includes the information linking the job to the clock time, the information linking the job to the vehicle, the information linking the job to the capacity, and the information linking the job to the cargo handling time.

In the next intermediate step (S22), the loading plan creation unit 40 calculates the cargo handling order, the cargo pool including a buffer range, and the cargo handling time. For example, the cargo handling order for the vehicle [1] is set to loading in the job 1 to the job 3 and unloading in the job 1, the job 3, and the job 2. Similarly, the cargo handling order for the vehicle [2] is set to loading in the job 4 to the job 6 and unloading in the job 6, the job 4, and the job 5.

The loading plan creation unit 40 assigns 6 to 8 packages to each of Job 1 and Job 6, assigns 3 to 5 packages to each of Job 2 and Job 5, and assigns 3 to 4 packages to each of Job 3 and Job 4 as the package pools. The loading plan creation unit 40 then sets the maximum time limit for the cargo handling based on the delivery plan. For example, the loading time for Job 1 is set to 20 minutes or less, and the sum of the loading time for Job 3 and the unloading time for Job 1 is set to 50 minutes or less, and so on.

In the output step (S23), the loading plan creation unit 40 creates information representing each order for loading and unloading, in addition to the information linking the task to the package and each package arrangement coordinates at the end of each task cargo handling. Specifically, for vehicle [1], the package arrangement and the cargo handling order that make feasible the loading in job 1 to job 3 and the unloading in job 1, job 3, and job 2 are calculated. Similarly, for vehicle , the package arrangement and the cargo handling order that make feasible the loading in job 4 to job 6 and the unloading in job 6, job 4, and job 5 are calculated. The loading plan creation unit 40 performs the calculation to seek a solution of the loading order and the unloading order satisfying such constrains that no unreasonable work should happen, no obstruction should happen during unloading, and the cargo handling time should not exceed the upper limit.

### Details of Output Processing Unit

The output processing unit 60 illustrated in FIG. 1 and FIGS. 23 to 25 automatically converts difficult-to-understand variable information into various diagram/charts that are easily understood by the user US. This enables the user US to immediately review the contents of the created plan without relying on external tools. In addition, the entire users US can share information in a standardized format. As a result, man-hours can be reduced.

Specifically, the output processing unit 60 performs visualizing the delivery plan (see functions 1 to 5 below) and the loading plan (see functions 6 and 7 below). In particular, in cases of real-time partial plan correction and iterative execution of small-scale simulation, the output processing unit 60 ensures system utility by means of such a response time that a result is immediately displayable after calculation completion.

The output processing unit 60 can present an optimized plan to the user US via the use of charts/tables of proprietary formats, even when it is difficult to cooperate with existing external tools and very difficult to interpret the raw data. In addition, the output processing unit 60 can perform information presentation using a 3D cargo configuration diagram, loading and unloading animation, etc., to assist the cargo handling faithfully following the optimum cargo handling order.

Here, the diagram/chart conversion function in the output processing unit 60 may be included in the user interface of the platform unit 10. However, for the following two reasons, it may be preferable that the server SV performs the diagram/chart conversion on the calculation result and outputs it without involving the user interface at the optimization. A first reason is that the utility does not get worse in cases of a one-to-one correspondence to a solution, a high frequency of use, and execution of the diagram/chart conversion for each optimization. A second reason is that the conversion and saving are heavy processes depending on format and the server can execute the processes at higher speed.

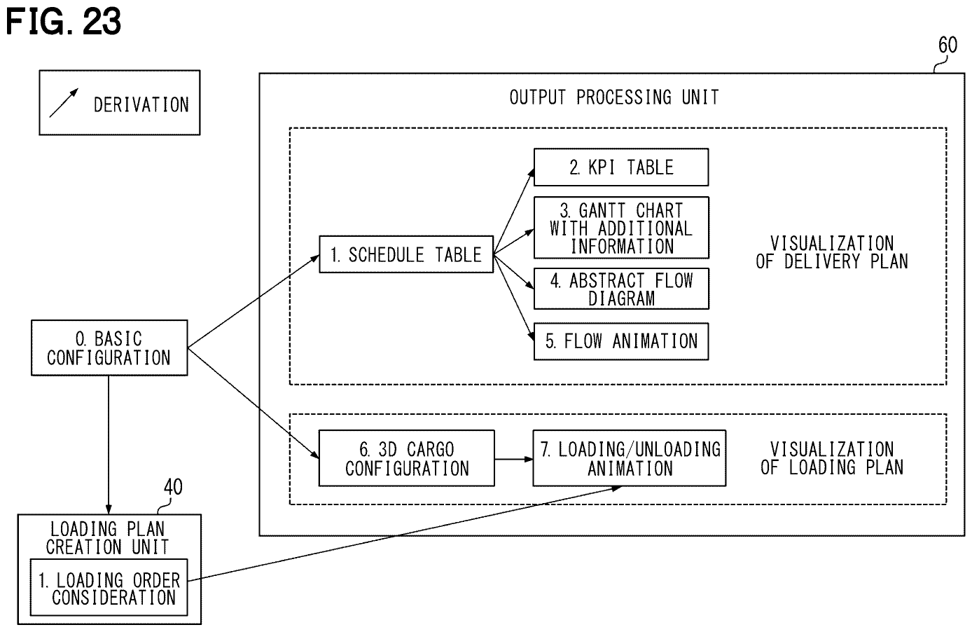

The output processing unit 60 includes multiple functional units derived from the basic configuration and the loading plan creation unit 40, as illustrated in FIG. 23. The output processing unit 60 uses the multiple functional units to reduce man-hours, risk, and versatility. In the below, the multiple functional units implemented in the loading plan creation unit 40 will be described in detail in turn.

### 1. Schedule Table

The output processing unit 60 converts the raw decision variable information indicating the assignment of packages and tasks into a timetable or a schedule table interpretable by the user US. By summarizing with inclusion of intermediate tasks, the output processing unit 60 converts the decision variable information into an easy-to-interpret form via linking the decision variable information to each driver and vehicle. This reduces the risk of errors and reduces man-hours in manual interpretation.

### 2. KPI Table

The output processing unit 60 calculates cost breakdown for fees, the number of vehicles, the number of people, the labor responsibility score, CO2 emissions, etc., based on the created schedule table. The output processing unit 60 outputs the diagram/chart representing the calculation result. The output processing unit 60 can calculate various costs without detailed check of the schedule table nor use of external tools. As a result, man-hours can be reduced.

### 3. Gantt Chart with Additional Information

The output processing unit 60 outputs a Gantt chart for each vehicle and driver based on the created schedule table. In addition, the output processing unit 60 displays detailed attributes of each task, driver changeover locations, container movement, etc., on the Gantt chart using broken lines and pop-up windows. This display enables the user US to ascertain a flow of the plan as a whole via a single diagram. In addition, the planner and operator can intuitively understand the time distribution of respective tasks based on drivers and vehicles, enabling them to ascertain the actual situation of the logistics in a short time.

### 4. Abstract Flow Diagram

The output processing unit 60 outputs an abstract flow diagram in which the base node arrangement and the base node size have been adjusted according to an amount of flow of incoming/outcoming vehicles and tasks. The presentation of the abstract flow diagram enables the user US to intuitively understand the movement of vehicles and the flow of tasks between bases. Furthermore, a Gantt chart for visual understanding of the information focusing each vehicle and driver is used in conjunction with the abstract flow diagram, whereby the user US can intuitively understand a base-focused amount of flow of incoming and outgoing vehicle and cargo quantity. As a result, it becomes easier to ascertain the actual logistics.

### 5. Flow Animation

The output processing unit 60 creates flow animations. In the flow animation, the bases and the route information based on actual latitudes and longitudes are displayed on the map. In addition, a video for tracking the location of the vehicle, driver, and container at each point in time is superimposed on the map. The flow animation enables the user US to ascertain a spatial-and-temporal logistics distribution at one time and acquire visual information based on the actual locations of the bases.

Here, the video is not suitable for ascertaining all information via a single frame. Therefore, it may be preferable to use the flow animation together with the Gantt chart and the abstract flow diagram. This enables the user US to check the information by linking the time distribution shown in the Gantt chart with the flow amount distribution shown in the abstract flow diagram. This combined use makes it easier for the user US to ascertain the actual logistics situation.

### 6. 3D Cargo Configuration

The output processing unit 60 displays a three-dimensional cargo configuration diagram (3D cargo configuration diagram) on the packages loaded on the vehicle (truck). The output processing unit 60 outputs a visual diagram of a corresponding vehicle cargo configuration using a three-dimensional model at the start and end of the loading and unloading for each task. The 3D cargo configuration diagram facilitates conveying the package arrangement to a person in charge of cargo handling. If the 3D cargo configuration diagram is unavailable, a cargo handling worker needs to load and unload packages by using, for example, the coordinate information alone. If the 3D cargo configuration diagram is available, the cargo handling worker can perform the cargo handling without errors, via recognizing the 3D cargo configuration considered in the loading plan.

### 7. Loading and Unloading Animation

The output processing unit 60 has a function of outputting the loading and unloading animations. This function is a function derived from the [1. Cargo Handling Order Consideration] in the loading plan creation unit 40. The output processing unit 60 acquires information on orders in which operations for loading and unloading are performed from the loading plan creation unit 40. The output processing unit 60 displays an animation (frame-by-frame) showing the cargo configuration when the package loading or unloading operation is performed. The output processing unit 60 sequentially displays the cargo configuration at the time of the loading or unloading operation, in a manner to add the cargo configuration to the 3D cargo configuration diagram.

In addition, the output processing unit 60 can display the loading and unloading animation that takes into account the circumstances for each location, such as forklift availability, the number of cargo-handling persons, and the direction in which the truck bed is opened. In the unloading animation, movement of people and the like may be added as auxiliary information to ensure successful loading and unloading operations. In this way, the cargo handling order is explicitly designated, so that the cargo handling person can easily understand the cargo handling order. As a result, the risk in cargo handling operations can be reduced. In addition, the output processing unit 60 can accurately communicate the correspondence relationship between the time required for loading and unloading and the work contents.

### Details of Output Processing Unit of Basic System

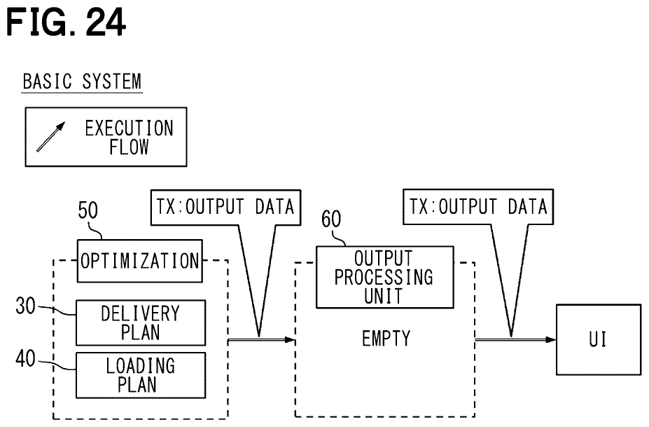

In the logistics planning system 100 employing the output processing unit 60 of the basic system illustrated in FIG. 24, the output data close to the raw variable information is transmitted from the optimization unit 50 to the output processing unit 60. Upon acquiring the output data for one case close to the raw variable information, the output processing unit 60 passes this output data directly to the user interface as it is. The output processing unit 60 relies on the user US for interpretation of the output data. The user US may use an external tool or interpret the raw data by herself/himself.

### Details of Output Processing Unit of Developed System

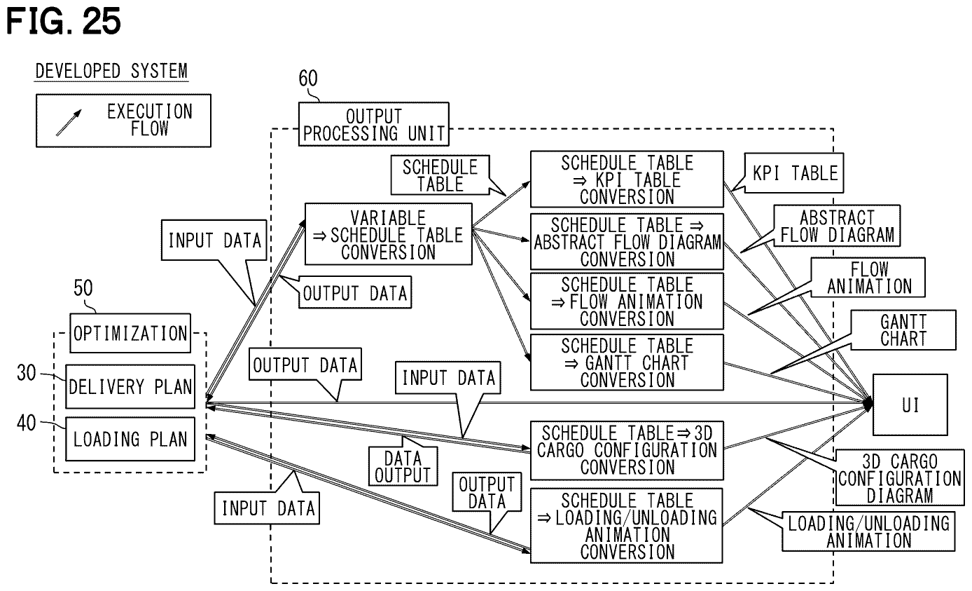

In the output processing unit 60 of the developed system illustrated in FIG. 25, the input data and the output data are transmitted from the optimization unit 50 to the output processing unit 60. The output processing unit 60 has a conversion function of converting the solution (set of variables) given by the optimization unit 50 into a diagram/chart.

The output processing unit 60 converts the input data and the output data into the schedule table. In addition, the output processing unit 60 converts the schedule table into the KPI table, the abstract flow diagram, the flow animation, and the Gantt chart. The output processing unit 60 transmits the schedule table visualizing the delivery plan, the KPI table, the abstract flow diagram, the flow animation, and the Gantt chart with additional information to the user interface.

The output processing unit 60 converts the input and output data (or the schedule table) into the 3D cargo configuration diagram and the loading and unloading animation. The output processing unit 60 transmits the 3D cargo configuration diagram and the loading and unloading animation visualizing the loading plan to the user interface.

The schedule table contains information equivalent to all of the input data and the output data except for the loading plan creation unit 40. Therefore, the input data and the output data may be discarded as long as two items remain. A first item is the schedule table. A second item is the 3D cargo configuration diagram and the loading animation or is the decision variable information of the loading plan creation unit 40.

### Overview of Embodiment

In the present embodiment described so far, the delivery plan for a vehicle to transport packages and the loading plan for loading the packages onto the vehicle are created in parallel. This facilitates ensuring flexibility in the delivery plan and the loading plan. As a result, the optimization process can create the delivery plan and the loading plan with high efficiency and accuracy.

In addition, the present embodiment defines a job as a unit linked to a delivery request used in the delivery plan. The delivery plan is created with a variablized capacity of the job. This improves flexibility in the delivery plan.

The present embodiment creates the loading plan for arranging the plurality of packages each being a box-shaped package of any size into a 3-dimensional container of any shape based on the size information of each of the plurality of packages This makes it possible to create the loading plan in which the packages of any standard are three-dimensionally loaded one by one. This improves flexibility in handleable loading plan, enabling handling various packages of any shape, specifically, packages of box shape and other shapes (when arranged at the top).

Furthermore, for creating the delivery plan by applying constraints designated by a user US, the present embodiment performs constraint setting based on the option information. Because of the benefits of the MTZ formulation and CP-SAT type solver described above, the present embodiment supports a wide range of constraints and implements additional constraints while suppressing an increase in calculation amount. The user US becomes able to select which constraint is to be applied. Therefore, high flexibility in constraint is ensured for delivery planning. The system has high utility accordingly.

In addition, as described in [3. Charging and refueling (2)] above, prepared for the delivery plan creation unit 30 are a first reference data (a first charging reference data) and a second reference data (a second charging reference data) each based on a remaining level of a battery for traveling mounted to the vehicle; and a duration of the remaining level. The first charging reference data is data indicating consumption efficiency as a function of the remaining level and the duration. The second charging reference data indicates efficiency in charging as a function of the remaining level and the duration. With reference to the two charging reference data, the delivery plan creation unit creates the delivery plan that corresponds to a traveling time and a charging time which are able to be designated by the user (US).

In addition, prepared for the delivery plan creation unit 30 are a first reference data (a first refueling reference data) and a second reference data (a second refueling reference data) each based on a remaining level of fuel in a fuel tank mounted to the vehicle; and a duration of the remaining level. The first refueling reference data is data indicating consumption efficiency as a function of the remaining level and the duration. The second refueling reference data indicates efficiency in refueling as a function of the remaining level and the duration. With reference to the two refueling reference data, the delivery plan creation unit creates the delivery plan that corresponds to a traveling time and a charging time which are able to be designated by the user (US). According to the above, only a necessary amount of electricity or fuel can be replenished at the necessary time, reducing the shortage and excess of the charging time and the refueling time in the delivery plan. As a result, efficient delivery plans conforming to actual conditions can be created.

Also, as described in [7. KPI Totaling (1)], the delivery plan creation unit 30 in the present embodiment performs totaling indicators KPI of multiple types related to a driver and the vehicle linked to the job and fees of multiple types paid to the driver and the vehicle. Then, the delivery plan creation unit 30 creates the delivery plan optimizing the indicators KPIs of the multiple types and the fees of the multiple types. Thus, by using the indicators KPI and wages paid (fees) as components of the objective functions, it is possible to create the delivery plan conforming to actual conditions.

Furthermore, as described in [10. Multiple Affiliated Bases], the delivery plan creation unit 30 in the present embodiment enables a limitation on the number of vehicles for each vehicle class and information on the number of drivers corresponding to the vehicle class to be set as constraints separately for each base so that constraints on a plurality of bases to which a plurality of transporters each being a vehicle belong are set. The delivery plan creation unit 30 then creates the delivery plan taking into account how many vehicles of which vehicle class can depart from each base. The above improves flexibility in the delivery plan while reflecting the actual constraints that may occur at the base.

In addition, as described in [18. Split Delivery], the delivery plan creation unit 30 in the present embodiment splits a single long-distance task for transporting the packages into small section jobs visiting a plurality of relay points. The delivery plan creation unit 30 creates the delivery plan with an additional constraint defining a connection relationship of the small section jobs and capacity allocation for the small section jobs. These functions enable the creation of the delivery plan supporting a long-distance task that cannot be carried out without being divided between multiple drivers.

Also, as described in [20. Route Selection], the delivery plan creation unit 30 in the present embodiment sets departure and arrival locations of the small section jobs and a time window reserved for each of the departure and arrival locations as new route selection flag variables. This enables a route to be selected that is not the shortest distance but is efficient in transportation depending on the conditions of the packages to be transported. As a result, it is possible to improve flexibility and efficiency in the delivery plan when the long-distance task is split for delivery or when delivery destination candidates are visited in the delivery.

Furthermore, as described in [13. Container Handover] above, when a swap body container vehicle allowing a container to be separated from a vehicle body is used as the transporter, the delivery plan creation unit 30 in the present embodiment creates the delivery plan optimizing an indicator KPI and fees by reducing a cargo handling time via exchange of the container. Specifically, variables are defined and set, including a variable that defines whether or not the vehicle is a SLOC vehicle, a variable that defines whether or not a container connection has been made, a variable that defines whether or not a cargo handling exemption has occurred, and a variable that defines the cargo handling time. Such utilization of SLOC vehicles, which can handover the entire container to another vehicle, will significantly reduce the cargo handling time, which in turn will minimize various KPIs and paid fees.

In addition, the loading plan creation unit 40 in the present embodiment creates the loading plan by using a function taking into account circumstances specific to each base and each package, a loading manner, and an increase or decrease in cargo handling time depending on loading coordinates. According to the above, it is possible to minimize the cargo handling time and set a limitation that reflects the circumstances, the loading manner, and the loading coordinates associated with the base and the packages. As a result, only such a cargo configuration that the work is completable within a given time and the delivery plan is feasible is output, so that the loading plan conforming to actual conditions can be created.

As described above in [1. Cargo Handling Order Consideration], the loading plan creation unit 40 in the present embodiment creates a cargo handling order for the packages based on a constraint on input and output, wherein the constraint is set for each of the packages loaded on a single transporter. This enables the loading plan creation unit 40 to output the feasible cargo handling order and the cargo configuration. As a result, the loading plan conforming to the actual condition can be created.

Furthermore, as described above in [3. Maximizing Stability], the loading plan creation unit 40 in the present embodiment calculate a score value indicating stability of the packages loaded on the vehicle or stability of the vehicle.

The loading plan creation unit 40 incorporates the score value indicating the stability into an objective function for the loading plan. In this way, the loading plan creation unit 40 outputs the most stable loading configuration possible, taking into account the trade-off between safety and efficiency. As a result, the loading plan conforming to the actual condition can be created.

In addition, as described above in [8. Vehicle Class Consideration], the loading plan creation unit 40 in the present embodiment creates the loading plan based on dimensions of the truck bed and the upper limit of the loading weight depending on the vehicle class of the vehicle and the rule related to the stability. Therefore, it is possible to take into account the trade-off with respect to changes in capacity, fees, and possible operating patterns resulting from changes in vehicle class. This improves flexibility in the delivery plan.

The output processing unit 60 in the present embodiment also displays a 3D cargo configuration diagram for the packages loaded on the vehicle, as described above in [7. Loading and Unloading Animation]. In addition, the output processing unit 60 displays animation of the cargo configuration diagram for the loading or unloading operation based on the information of the loading or unloading operation order. Because of this, the cargo handling order is explicitly instructed to cargo handling workers in charge for the loading and unloading operations. As a result, risks in cargo handling operations can be reduced.

### Other Embodiments

Although one embodiment according to the present disclosure has been described above, the present disclosure is not construed as being limited to the embodiment and is applicable to various embodiments and combinations without departing from the spirit and scope of the present disclosure.

Each of functions provided by the client terminal CT and the server SV, etc., in the above embodiment may be provided by software and hardware executing the software, by software only, by hardware only, or by a complex combination thereof. Furthermore, in a case where the function is provided by an electronic circuit as hardware, each function may be provided by a digital circuit including a large number of logic circuits or by an analog circuit. The software for such functions may include, at least in part, a code automatically created by a neural network or a language model.

The processor of the above-described embodiment is not limited to a chip configuration individually mounted on a printed circuit board. The processing unit may be implemented in ASIC, SoC, chiplet integration, FPGA, etc. ASIC is an Application Specific Integrated Circuit. SoC is a System on Chip. FPGA is a Field-Programmable Gate Array.

The storage (non-transitory tangible computer readable storage medium) storing thereon various programs, etc., in the above embodiment may be modified as appropriate. Furthermore, the storage is not limited to being mounted on a circuit board but may be provided in a form of a memory card or similar which is inserted into a slot unit and electrically connected to a control circuit of a control panel. The storage may be an optical disk, a hard disk drive, and a solid-state drive that serves as a source of copying or distribution of the program to a control panel, etc.

What is claimed is:

1. A logistics planning program stored in a non-transitory storage medium, the logistics planning program causing at least one processor to function as:
a delivery plan creation unit that creates a delivery plan for a transporter to transport packages; and
a loading plan creation unit that creates a loading plan for loading the packages onto the transporter,
wherein
the delivery plan creation unit and the loading plan creation unit create the delivery plan and the loading plan in parallel and perform an optimization process to optimize the delivery plan and the loading plan.

2. The logistics planning program according to claim 1, wherein:
the delivery plan creation unit defines a job as a unit linked to a delivery request used in the delivery plan and creates the delivery plan with a variablized capacity of the job.

3. The logistics planning program according to claim 1, wherein:
the loading plan creation unit creates the loading plan for arranging the packages each being a box-shaped package of any size in a three-dimensional container based on size information of each of the packages.

4. The logistics planning program according to claim 1, wherein:
for creating the delivery plan by applying constraints designated by a user, the delivery plan creation unit performs constraint setting based on option information to support a wide range of constraints and implement additional constraints while suppressing an increase in calculation amount, so that the user can select which constraint is to be applied.

5. The logistics planning program according to claim 1, wherein:
for the delivery plan creation unit, a first reference data and a second reference data are prepared each based on: a remaining level of a battery for traveling mounted to the transporter or a remaining level of fuel in a fuel tank mounted to the transporter; and a duration of the remaining level;
the first reference data indicates consumption efficiency as a function of the remaining level and the duration;
the second reference data indicates efficiency in charging or refueling as a function of the remaining level and the duration; and
with reference to the first reference data and the second reference data, the delivery plan creation unit creates the delivery plan that corresponds to a traveling time and a charging or refueling time which are able to designated by a user.

6. The logistics planning program according to claim 1, wherein:
the delivery plan creation unit defines a job as a unit linked to a delivery request used in the delivery plan, performs totaling indicators KPI of multiple types related to a driver and the transporter linked to the job and fees of multiple types paid to the driver and the transporter, and creates the delivery plan optimizing the indicators KPI of the multiple types and the fees of the multiple types.

7. The logistics planning program according to claim 1, wherein:
the transporter is a vehicle;
the delivery plan creation unit enables a limitation on the number of vehicles for each vehicle class and information on the number of drivers corresponding to the vehicle class to be set as constraints separately for each base so that constraints on a plurality of bases to which a plurality of vehicles belong are set; and
the delivery plan creation unit creates the delivery plan taking into account how many vehicles of which vehicle class can depart from each base.

8. The logistics planning program according to claim 1, wherein:
the delivery plan creation unit splits a single long-distance task for transporting the packages into small section jobs visiting a plurality of relay points; and
the delivery plan creation unit create the delivery plan with an additional constraint defining a connection relationship of the small section jobs and capacity allocation for the small section jobs.

9. The logistics planning program according to claim 8, wherein:
the delivery plan creation unit sets departure and arrival locations of the small section jobs and a time window reserved for each of the departure and arrival locations as new route selection flag variables.

10. The logistics planning program according to claim 1, wherein:
when a swap body container vehicle allowing a container to be separated from a vehicle body is used as the transporter, the delivery plan creation unit creates the delivery plan optimizing an indicator KPI and fees by reducing a cargo handling time via exchange of the container.

11. The logistics planning program according to claim 1, wherein:
the loading plan creation unit creates the loading plan by using a function taking into account circumstances specific to each base and each package, a loading manner, and an increase or decrease in cargo handling time depending on loading coordinates.

12. The logistics planning program according to claim 1, wherein:
the loading plan creation unit creates a cargo handling order for the packages based on a constraint on input and output, wherein the constraint is set for each of the packages loaded on a single transporter.

13. The logistics planning program according to claim 1, wherein:
the transporter is a vehicle;
the loading plan creation unit calculates a score value indicating stability of the packages loaded on the vehicle or stability of the vehicle; and
the loading plan creation unit incorporates the score value indicating the stability into an objective function for the loading plan.

14. A logistics planning system comprising:
at least one memory storing a program and at least one processor that executes the program to implement:
a delivery plan creation unit that creates a delivery plan for a transporter to transport packages; and
a loading plan creation unit that creates a loading plan for loading the packages onto the transporter,
wherein the delivery plan creation unit and the loading plan creation unit create the delivery plan and the loading plan in parallel and perform an optimization process to optimize the delivery plan and the loading plan.

15. A logistics planning method executed by at least one processor of a logistics planning system that implements: a delivery plan creation unit that creates a delivery plan for a transporter to transport packages; and a loading plan creation unit that creates a loading plan for loading the packages onto the transporter,
the logistics planning method comprising:
by the delivery plan creation unit and the loading plan creation unit, creating the delivery plan and the loading plan in parallel and performing an optimization process to optimize the delivery plan and the loading plan.
